(19) United States
(12) Patent Application Publication
(10) Pub. No.: US 2013/0040825 A1
(43) Pub. Date: Feb. 14, 2013

(54) DNA DAMAGE DETECTION ASSAY AND METHOD

(71) Applicants: Maria de Lurdes Vital Ferreira Queimado, Oklahoma City, OK (US); Wilbur K. Mills, Oklahoma City, OK (US); Maria de Lurdes Vital Ferreira Queimado, Oklahoma City, OK (US)

(72) Inventors: Maria de Lurdes Vital Ferreira Queimado, Oklahoma City, OK (US); Wilbur K. Mills, Oklahoma City, OK (US); António Manuel Corga Reis, Oklahoma City, OK (US)

(21) Appl. No.: 13/565,604

(22) Filed: Aug. 2, 2012

Related U.S. Application Data
(60) Provisional application No. 61/514,704, filed on Aug. 3, 2011.

(51) Int. Cl. C40B 20/00; C40B 40/06; C40B 30/04

(52) U.S. Cl. 506/2; 506/9; 506/16

(57) ABSTRACT

A novel assay for determining in vivo or in vitro strand-specific endogenous and/or induced damage in a DNA sample. The method is rapid, reliable, and highly sensitive, and comprises a primer-anchored DNA damage detection assay (“PADDA”). The method can be used for, but is not limited to, quantification and/or mapping of overall or site-specific damage in the template DNA sample. By quantification or mapping of DNA damage, this assay can be used to assess individual or a tumor's susceptibility to specific genotoxics (e.g., tobacco and chemotherapeutic agents) and therefore determine cancer risk and therapeutic response. Additionally, by quantification or mapping of DNA damage, this assay can be used to determine multiple responses of certain genes to a variety of DNA lesions in a research oriented setting.

### CROSS-REFERENCE TO RELATED APPLICATIONS

This application claims the benefit under 35 U.S.C. 119(e) of U.S. Provisional Application Ser. No. 60/514,704, filed Aug. 3, 2011, the entire contents of which are hereby expressly incorporated by reference herein.

### STATEMENT REGARDING FEDERALLY SPONSORED RESEARCH OR DEVELOPMENT

This invention was made with government support under Contract Number CA117316 awarded by the National Institutes of Health. The government has certain rights in the invention.

### BACKGROUND

DNA damage, due to both exogenous and endogenous causes, especially endogenous damage associated with reactive oxygen species (ROS), likely contributes to a large fraction of human cancers (1) and plays a role in the pathogenesis of aging and many degenerative diseases (2,3) perhaps up to 80 to 90%. In addition, it is well established that defects in genes required for the repair of DNA damage can result in a genetic predisposition to cancer and aging syndromes (4). Endogenous DNA damage is typically processed by base excision repair (BER), which processes primarily small, helix non-distorting base lesions and abasic sites (5). However, there is some overlap with other DNA repair pathways, including nucleotide excision repair (NER) which has been shown to repair specific types of oxidative DNA damage (6). There are more than 20 different oxidative DNA base lesions (7) and it is grossly estimated that 10,000 oxidative hits occur per cell per day in the mammalian genome (8).

Transcription of DNA is critical for cell function and survival, and thus unrepaired or unrecognized DNA damage in the transcribed strand can be deleterious for the cell. Transcription coupled repair (TCR) of bulky DNA adducts is well characterized in eukaryote cells and results in more rapid repair of the transcribed strands compared to the non-transcribed strands of expressed genes. Deficient TCR has been implicated or linked to xeroderma pigmentosum, cockayne syndrome (CS), trichothiodystrophy (TTD), and UV-sensitive syndrome (UVS), although in vivo TCR observations have not been fully validated with eukaryotic cell-free systems (17). TCR was originally documented for DNA damage induced by UV light and believed to operate through NER pathways, but later reports suggested that oxidative damage is also preferentially repaired in a transcription-dependent manner (18,19). Nonetheless, several key papers supporting transcription-coupled repair of oxidative damage have been retracted and this subject remains a matter of intense debate (20). Prior to the work described in the present patent application, there was no direct evidence for transcription-coupled repair of oxidative or endogenous DNA damage.

Xeroderma pigmentosum is an extensively studied disease associated with defects in nucleotide excision repair or defects in translesion DNA synthesis, in which patients are highly prone to UV induced cancers (65). A defect in one of the genes associated with this disease, xeroderma pigmentosum complementation group C, or Xpc, is responsible for removing a variety of lesions including bulky adducts and UVB induced modifications in di-pyrimidine sites in DNA such as cyclobutane pyrimidine dimers (CPD) and 6-4 photoproducts in inactive bulk DNA and the non-transcribed strand (NTS) of transcriptionally active genes (65-68). Previously, we mapped the spectrum of mutations in tumors arising in the p53 gene in Xpc defective mice exposed to UVB, and found remarkably that a non-dipyrimidine site produced 64% of the tumors analyzed in Xpc deficient mice after UVB irradiation (69), suggesting a novel DNA lesion produced at this site by UVB and repaired by Xpc.

Individual levels of DNA damage reflect a balance between genotoxic exposure, anti-oxidant mechanisms and individual repair capacity. Tobacco smoking causes many types of DNA damage, is associated with unique p53 “mutational fingerprints” (70,71), and is the main risk factor for two of the most common malignancies worldwide: lung and head and neck cancer (72). The quantification in a single setting of many types of tobacco-induced DNA damage in vivo has never been reported. Tobacco-exposure can generate more than 100 different types of DNA lesions. However, until recently, only a few types of tobacco-induced DNA lesions could be accessed in human tissues and none of the available methodologies allowed for high-throughput screening. In vitro studies have mapped BPDE adduct formation after exposure of tissue culture cells to BPDE and suggested that both preferential BPDE adduct formation and slow repair of specific damaged nucleotides contribute to the p53 mutational hotspots found in tobacco-associated cancers. However, the mapping of in vivo tobacco-induced DNA damage in smokers and ex-smokers has never been performed.

Insults to the DNA resulting from exposure to genotoxic substances cause cancer. Importantly, chemotherapy and radiotherapy rely precisely on the induction of DNA damage to kill cancer cells. Available data indicate that variations in DNA damage and DNA repair capacity influence patient's risk to develop cancer and patient's response to chemo- and radio-therapy (73). However, no predictive markers of cancer risk or response to treatment have yet been established.

Unfortunately, technical limitations of currently available assays have led to major difficulties in the estimation of precise levels of DNA damage in different cell systems and how it impacts cell fate and human health. Accordingly, the European Standards Committee on Oxidative DNA Damage (ESCODD) “was set up to resolve problems in the measurement of DNA oxidation that have resulted in varying estimates of the extent of this damage in humans” (cited in ESCODD, 2003).

In spite of this, currently there are still no practical assays to quantify endogenous DNA damage. Despite the profound implications of endogenous DNA damage in human diseases, the most commonly used assays for the detection of induced oxidative DNA damage, Southern blot analysis, high performance liquid chromatography with electrochemical detection (HPLC-ECD) and enzymic assays have limited applications for the study of in vivo endogenous DNA damage (9,10). Southern blot analysis for DNA damage detection, for example, is a multi-step procedure that requires large amounts of DNA and allows only a semi-quantitative analysis of DNA strand breaks (11). HPLC-ECD can accurately measure induced oxidative DNA damage and is valuable to measure specific DNA damage lesions in body fluids, but suffers from high variable estimates of the background level of DNA oxidation and requires several days to complete depending on the number of samples (10). Enzymic methods, such as the comet assay (single cell alkaline gel electrophoresis), allow the detection of single and double strand breaks as well as alkali-labile DNA sites under alkaline conditions (10). These methods have high sensitivity and low background and are widely used for the detection of induced oxidative DNA damage (10,12), but they need standardization and inter-laboratory validation (10). Although Southern blot, chromatographic and enzymic methods can detect and quantify some specific oxidative DNA lesions, they are tedious and have inadequate sensitivity for the study of in vivo endogenous DNA damage (10). Also, they reflect only a sub-fraction of induced oxidative DNA lesions and cannot map lesion distribution, an important player in repair efficiency and cell fate. PCR-based assays take advantage of polymerase elongation properties as a sensor for damage on the template DNA (13-16), and are currently one of the most reliable strategies to map and quantify chemical or radiation induced DNA damage. However, they are quite time-consuming and require a high degree of optimization for reliable damage quantification. Additionally, their relatively low sensitivity prevents their use for the detection of overall levels of endogenous DNA damage (14-16). Therefore, due to technical limitations, the precise levels of endogenous DNA damage in different cell systems and how they impact cell fate and human health are still largely unknown (7,10).

As is evident, improved methods for the detection of DNA damage are of major interest for multiple purposes, from food screening to multiple studies employing human DNA. In addition, it is widely recognized that an accurate knowledge of the amount of DNA damage present in cells is a relevant factor for assessing cancer risk and for cancer prevention. Therefore, accurate detection and quantification of DNA damage is a central need in modern biomedical and clinical research involving cancer as well as a host of other human disorders associated with DNA damage. More knowledge in this area will: a) contribute to a better understanding of the biological responses to DNA damage; b) permit estimation of individual risk to cancer and other conditions after exposure to specific genotoxics; c) permit estimation of the DNA repair capacity in various cell types; and d) very likely improve health recommendations and therapies.

It is thus an objective of the presently disclosed and claimed inventive concepts to provide new, more sensitive and rapid methods for the detection of endogenous and induced DNA damage.

### BRIEF DESCRIPTION OF THE DRAWINGS

FIG. 1 (A-D) is a schematic representation of “quantification” and “fingerprinting” embodiments of PADDA (“Primer-Anchored DNA Damage Detection Assay”) and identified DNA damage. “Q-PADDA” refers to “quantification-type” PADDA and “f-PADDA” refers to “fingerprinting-type” PADDA.

FIG. 2 is a graph showing Vent exo− behavior at abasic, 8-OxoG, 8-oxodA, and thymine glycol engineered DNA lesions detected by f-PADDA. This figure shows that the sensitivity of our assay in engineered lesions is 100% for the abasic site, 85% for the 8-OxoG lesion, 100% for the 8-oxodA lesion, and 67% for the thymine glycol lesion. This high sensitivity to detect lesions that are relatively frequent and well established biomarkers of oxidative stress supports the use of PADDA for the mapping and quantification of endogenous DNA damage.

FIG. 3A, B shows graphical evidence that PADDA has very high sensitivity to quantify oxidative DNA damage and is able to discriminate a dose response over a wide range of H₂O₂ concentrations, as determined by in vitro exposure of naked DNA to H₂O₂. FIG. 3A is a graph showing characterization of real-time PCR for q-PADDA. To test the applicability of real-time PCR used for q-PADDA over a wide range of template DNA concentrations, real-time PCR was performed on a 1 kb fragment of the CAN1 gene for oligos (A) Sc-CAN1-1251-1224 and Sc-CAN1-1185-1214; (B) Sc-CAN1-1251-1224 and Sc-CAN1-740/780; (C) Sc-CAN 1-1117/1151 and Sc-CAN1-1209/1173; (D) Sc-CAN1-1117/1151 and Sc-CAN1-1769/1737. The amplification was performed over a range of 80 pg to 80 fg template CAN1 DNA. The amplification resulted in an inverse linear relationship with the Cₚ values and the dilution of total DNA templates with correlation coefficients between 0.9899 and 0.9998. In FIG. 3B, to determine the sensitivity and dynamic range of q-PADDA to different spectra of DNA lesions, we quantified induced DNA damage after in vitro exposure to H₂O₂. Oxidative damage is one of the most frequent types of endogenous damage present in vivo. Compared to the control, q-PADDA detected a significant increase in total CAN1 DNA damage for each H₂O₂ dose escalation, from the lowest dose tested (1 μM) to the highest (500 mM). When analyzed by DNA strand, q-PADDA detected a significant (p<0.005) increase in damage in the NTS and TS for as little as 1 μM and 10 μM H₂O₂, respectively. Based on the reported equivalence between H₂O₂ in vitro and in vivo doses (75,76), q-PADDA is at least 10 to 100 fold more sensitive than the most sensitive assays currently used to quantify induced oxidative damage: the comet assay (77), SL-RT PCR (78), and Q-PCR (78). Plus, in contrast with these assays, PADDA does not require enzymic hydrolysis of the lesions and can discriminate damage between each DNA strand.

FIG. 4 shows graphical evidence that PADDA detects an increase in in vivo DNA damage induced by a dose escalation (A) of methyl methanosulfonate (MMS) or by just an increase in exposure time to MMS (B). Data shown represents mean±sem.

FIG. 5 shows graphical evidence that PADDA detects an increase in in vitro DNA damage induced by a MMS dose escalation. Data shown represents mean±sem. Note that most of the MMS-induced DNA damage quantified by PADDA is not detectable by other polymerase based assays unless the lesions are enzymatically removed. PADDA is more sensitive to detect in vivo (FIG. 4) than in vitro (FIG. 5) MMS-induced DNA damage, because in vivo, methylated bases are recognized and cleaved by DNA glycosylases, originating abasic sites which block Vent exo−.

FIG. 6 shows graphical evidence that PADDA detects deamination of unmethylated cytosines to uracil as induced by exposure of naked DNA to serial dilutions of by sodium bisulfite. This is an extremely important property, as deamination of cytosines to uracil, is one of the most promutagenic DNA changes in vivo. Data shown represents mean±sem.

FIG. 7 shows graphical evidence that includes graphs which show levels of endogenous DNA damage in WT and BER⁻ cells. (A) Extension sizes (mean±s.d.) observed for WT and BER strains in exponential and stationary phases. Analysis of variance compared the natural log of extension sizes for the VVT and BER⁻ genotypes. *p=0.005, **p=0.008, ***p=8.6×10⁻¹⁰. (B) Distribution of extension sizes observed for each sequenced extended product obtained from WT and BER⁻ cells in stationary phase. (C) Observed extension sizes distributions for BER⁻ cells in stationary phase before (unrepaired) and after (repaired) in vitro repair.

FIG. 8 is a graph showing the rate of nucleotide misincorporation (LBMs or SMs per base) during primer-extension in genomic DNA, modeled by logistic regression. In WT cells, the misincorporation rate was significantly higher in stationary than in exponential phase (*p=2×10⁻¹⁵¹). In exponential phase, BER⁻ extended products had a significantly higher rate of misincorporation than WT extended products (**p=2×10⁻²²¹).

FIG. 9 is a graph showing co-localization of endogenous nucleotide damage detected in the NTS and spontaneous mutations in the CAN1 gene. Shown is a representative fragment of the CAN1 ORF (CAN1, X03784) nucleotides 1180 to 1215. Y-axis values represent number of instances of nucleotide damage mapped by f-PADDA (top panel) or mutations previously reported in literature (bottom panel).

FIG. 10 is a graph showing strand-specific DNA damage quantification by q-PADDA in WT and BER″ cells. Fold difference reflects damage normalization against in vitro repaired DNA extracted from WT cells in exponential and stationary phase of growth. Data shown represents mean±s.d. *p=0.0001, **p=0.001, ***p=0.002, ****p=2×10⁻⁹, *****p=0.007, ******p=5×10⁻⁶.

FIG. 11 is a graph showing fold difference in damage compared to log phase WT for each strand using q-PADDA and the IQ5 Real-Time PCR detection System with the probe method. Q-PADDA was performed in the CAN1 gene of WT and repair defective yeast. No normalization against in vitro repaired DNA was performed.

FIG. 12 is a graph showing damage detected in yeast using the digital droplet PCR approach with q-PADDA demonstrating the proof of principle of the method. Q-PADDA was performed in the CAN1 gene of WT and repair defective yeast.

FIG. 13 is a graph showing Average Elongation Size (AES) in each genotype and time period. Mice WT or defective in nucleotide excision repair (Xpc−/−) were irradiated or not with UVB and allowed to repair for the specified time points. F-PADDA was then performed on the p53 gene. Data shows that DNA damage persists significantly longer (revealed by shorter elongations) in the NTS of p53 in mice defective in nucleotide excision repair (Xpc−/−)

FIG. 14 is a graph showing Percentage of Damage detected in codon 122 of the p53 gene in WT and Xpc−/− mice 24H after UVB. Mice were irradiated or not with UVB and allowed to repair for the specified time points. F-PADDA was then performed on the p53 gene. Our methodology demonstrates a significant increase (p=0.0109, Fisher's Exact Test) of putative lesions on the NTS of codon 122 in skjn genomic DNA from Xpc^{-/-} Trp53^{+/-} mice 24 h after a single exposure to UVB-radiation. This result shows that after UVB-radiation exposure Xpc^{-/-} animals still have significant levels of damage on the NTS of codon 122, and is consistent with the model that the tumor mutations we previously reported at this site may arise from persistence of unrepaired lesions which require XPC for repair.

FIG. 15 is a graph comparing F-PADDA signature damage in codon 122 in Xpc−/− mice 24H after UVB compared with reported signature mutations in codon 122 in Xpc−/− mice. Mice were irradiated or not with UVB and allowed to repair for the specified time points. F-PADDA was then performed on the p53 gene.

FIG. 16 is a graph showing Misincorporation frequency in WT and Xpc−/− mice not irradiated with UVB. f-PADDA was performed on the p53 gene. This graph documents the ability of PADDA to detect endogenous DNA damage in diverse mice strains.

FIG. 17 is a graph showing Fold Damage frequency per 10,000 bases in each strand of smokers and non-smokers in humans. F-PADDA was performed in DNA from buccal cells collected by oral mucosa scrapings of healthy non-smoking and smoking patients. F-PADDA was performed in exons 7 and 8 of the p53 gene. A significant increase in DNA damage associated with smoking is detected by our assay. Note also the feasibility of our assay even when extremely low amounts of DNA are available.

FIG. 18 is a graph showing misincorporation (damage by-passable with errors) frequency calculated as the sum of SM's and LBM's for each strand/genotype/1000 bases of extended product per experiment. F-PADDA results are from DNA from buccal cells of healthy non-smoking and smoking patients. F-PADDA was performed in exons 7 and 8 of the p53 gene.

FIG. 19 is a graph showing percentage of detected damage in p53 exons for each strand that occurred at a site of previously reported tobacco induced tumor mutations. F-PADDA results are from DNA from buccal cells of healthy non-smoking and smoking patients. F-PADDA was performed in exons 7 and 8 of the p53 gene.

FIG. 20 is a graph showing fold difference in damage in each strand of smokers normalized to non-smokers using q-PADDA. Q-PADDA was performed in exons 7 and 8 of the p53 gene.

### DETAILED DESCRIPTION

Currently, there are various techniques to detect DNA damage, and particularly DNA base damage. Available PCR-based assays take advantage of polymerase elongation properties as a sensor for damage on the template DNA and are currently among the most reliable strategies to map and quantify chemical- or radiation-induced DNA damage (13,16). However, these methods require a high degree of optimization for reliable damage quantification and are quite time-consuming. Additionally, due to multiple limitations, they are neither widely used nor reliable for the detection of endogenous DNA damage. These limitations include: (i) low sensitivity which prevents their use for the detection of endogenous, strand specific DNA damage (14-16,38), (ii) high background (14,38), (iii) capacity to identify only technically introduced DNA strand breaks (14), (iv) requirement of radioactive materials and multiple step optimization for each genomic area in study (14,15), and (v) end-point PCR analysis (14-16).

The presently disclosed and claimed inventive concepts solve these relevant limitations of existing techniques. The present disclosure describes a novel assay for mapping and quantifying both in vitro or in vivo strand and/or nucleotide-specific endogenous and induced DNA damage. The method can be used to assess DNA damage in any type of organism, including prokaryotes (e.g., bacteria), eukaryotes, and archaeons (Archaea). The method is rapid, reliable, and highly sensitive, and comprises a primer-anchored DNA damage detection assay (“PADDA”). This damage detection assay relies on the principle that the presence of DNA damage on the template can change the polymerase replicative rate leading to lesion bypass with or without misincorporation, or to lesion-dependent replicative arrest before or opposite to the damaged base. The present DNA damage detection assay (PADDA) has higher sensitivity than previous assays in the detection of induced strand specific DNA damage. Additionally, PADDA is the only assay able to quantify and map endogenous strand- and nucleotide-specific DNA damage. Indeed, PADDA is the first reported assay to detect differences in levels of endogenous DNA damage between strands within the same genotype. This advantage has major implications for the study of numerous cellular processes involved in the processing of DNA damage and transcriptional regulation of DNA repair. Additionally, after genomic DNA extraction, data is generated with PADDA in five hours or less for the q-PADDA version and seven hours or less for dilution method of the f-PADDA version, with the use of harmless, relatively inexpensive materials and simple procedural setup.

In contrast with previously existing assays, PADDA has several conveniences including, for example, simple protocol, low cost, detection of damage caused by a broad range of chemically distinct lesions, detection at the single nucleotide/strand/allele/cell level (when applied to genomic DNA), effectiveness with a small amount of DNA, fast results and easy setup by minimally trained individuals working in standard research or clinical laboratory. Furthermore, the high sensitivity of PADDA to detect endogenous DNA damage at the strand level with q-PADDA and nucleotide level with f-PADDA represents a major advancement over conventional assays. These conveniences represent relevant advantages over existing techniques and make this new approach attractive for wide use. Particular advantages of the present assay, PADDA, described herein over existing traditional analytical approaches include, but are not limited to the following:

(1) When used to screen genomic DNA, the present assay can provide important insights into damage and repair at the single nucleotide/strand/allele/cell level.

(2) Unlike prior techniques, the present assay is able to test for specific DNA bases damaged endogenously, or exogenously by a broad range of carcinogens.

(3) When applied to genomic DNA, the present assay can detect and quantify a broad range of base (and nucleotide) lesions of chemically distinct nature at the single nucleotide/strand/allele/cell level in any region of the genome. Each set of experiments optimally screens a region of ˜1,000 bases; many regions can be screened simultaneously if different tags and/or probes are used; additionally, larger regions may be screened.

(4) The present method does not require the use of special, expensive or hazardous reagents (such as radioactive materials), dedicated equipment for q-PADDA or specialized skills; for f-PADDA, access to a DNA sequencing machine is required. For q-PADDA, access to a real-time PCR machine or Bio-Rad's Qx100 digital droplet PCR system is required.

(5) The present method can be applied to virtually any nucleic acid sequence (such DNA, RNA, and artificially generated nucleic acid sequences) from virtually any species, including humans, animals, plants, fungi, or microorganisms including bacteria, protozoa, and algae.

(6) The present assay can be performed on small amounts of DNA (e.g. 100 nanograms of genomic DNA or less) from any tissue collected by invasive (e.g., biopsy) or non-invasive (e.g., oral mucosa brushing) methods.

(7) The present method uses a high-throughput design to quantify the levels of induced or endogenous strand-specific DNA damage (q-PADDA). The method uses a high-throughput design to quantify levels and map at nucleotide resolution endogenous and induced DNA damage (f-PADDA).

(8) Results using the present assay can be obtained in less than 5 hours for q-PADDA and less than 7 hours for the dilution method of f-PADDA. Therefore, the new assay is suitable for high throughput use.

(9) The present assay is amenable to a variety of applications in research or clinical laboratories. Additionally, it is particularly important for population screening as currently there is no simple assay for this purpose.

(10) Individuals with only standard laboratory training (such as research technicians) can easily carry out the protocol of the present assay.

Further, PADDA has other advantages over existing PCR-based techniques as summarized in Table 1 below.

TABLE 1

| Category of | | | | | | | |
|---|---|---|---|---|---|---|---|
| assay | LM- | TD- | | | | | |
| comparison | PCR | PCR | QPCR | ss-QPCR | sslig-PCR | q-PADDA | f-PADDA |
| Lesion-specific | Yes | No | No | No | No | No | No |
| detection by | | | | | | | |
| enzymes | | | | | | | |
| Detection of a | No | Yes | Yes | Yes | Yes | Yes | Yes |
| broad | | | | | | | |
| spectrum | | | | | | | |
| of lesions | | | | | | | |
| Detection at | No | No | No | No | No | No | Yes |
| the single | | | | | | | |
| nucleotide | | | | | | | |
| level | | | | | | | |
| Detection at | Yes | Yes | No | Yes | Yes | Yes | Yes |
| the single | | | | | | | |
| strand level | | | | | | | |
| Detection at | No | No | No | No | No | Yes | Yes |
| the single | | | | | | | |
| allele | | | | | | | |
| level | | | | | | | |
| Detection at | No | No | No | No | No | Yes | Yes |
| the single cell | | | | | | | |
| level | | | | | | | |
| Radioactive | Yes | Yes | Yes | Yes | Yes | No | No |
| reagents | | | | | | | |
| required | | | | | | | |
| Technically | No | No | No | No | No | Yes | Yes |
| easy/fast | | | | | | | |
| Detection of | No | No | No | No | No | Yes | Yes |
| endogenous | | | | | | | |
| DNA damage | | | | | | | |

Comparison of Assays for Detection of DNA Damage.
LM-PCR means ligation mediated PCR (13);
TO-PC R means terminal transferase-dependent PCR (13).
QPCR means quantitative PCR (14).
ss-Q PCR means strand-specific QPCR (14).
Sslig-PCR means single-strand ligation PCR (14).

The following is a non-inclusive summary of some of the steps which may be used in the PADDA assay of the presently disclosed and claimed inventive concepts and which may be different from other polymerase-based DNA damage detection assays. It is understood that the presently disclosed assays may use steps which are different from those listed below, and may not include all of the steps listed below.

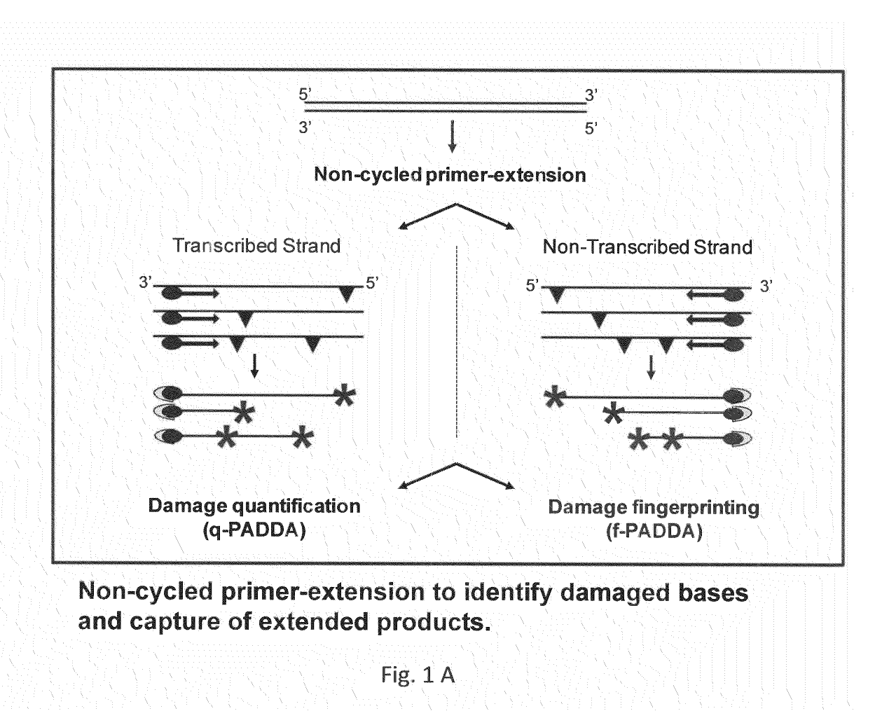

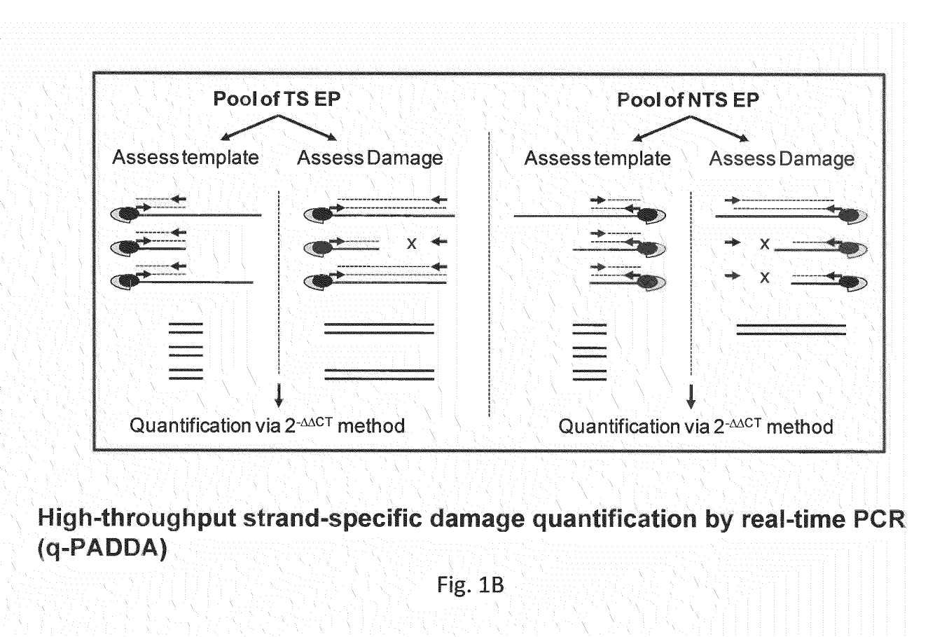

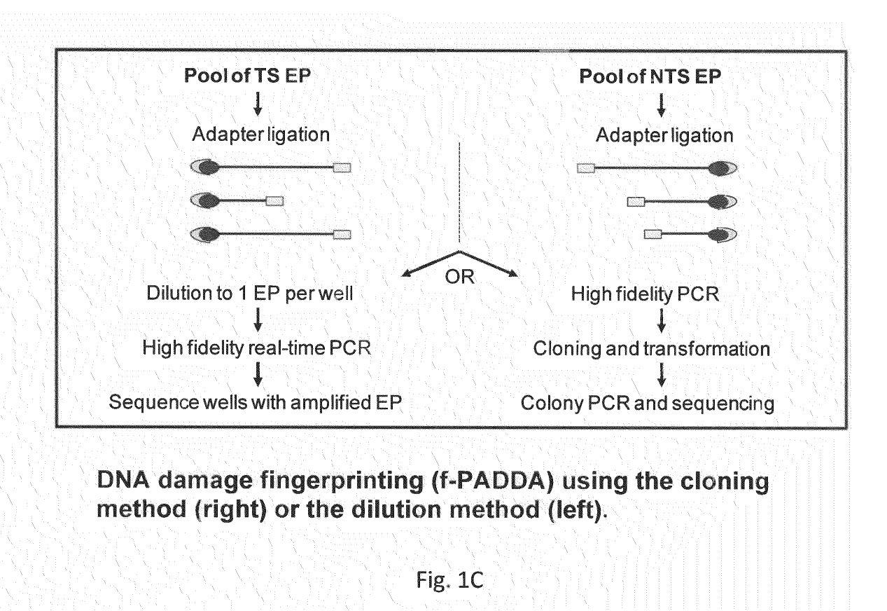

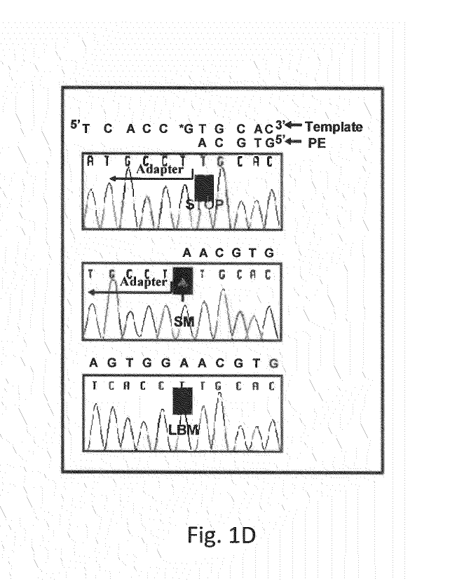

Primer Extension
A. Non-cycled strand-specific primer extension (PE).
   Use of a polymerase in the non-cycled primer extension step without using DNA repair enzymes to remove lesions. Theoretically any polymerase can be used for different types of data collection, including, but not limited to:
   DNA polymerases I-IV, POLA1, POLA2: Pol α Pol ε Pol δ POLB: Pol β POLG, POLG2: Pol γ: POLD1, POLD2, POLD3, POLD4: Pol δ:POLE, POLE2, POLE3: Pol ε: POLH, POLI, POLK: η, I, K, and Rev1 POLQ: ‘θ POLL: λ: φ: σ POLM: μ, Dp04, SSO, AlN-SSO, Taq, Vent, Vent (−), Pfu, Phusion, Phusion Hot Start, Phusion Hot Start II, phi29; From New England Biolabs9M9° Nₘ™ DNA, PolymeraseBst DNA Polymerase, Large FragmentBst DNA Polymerase, Full Length Bsu DNA Polymerase, Large fragment Crimson Taq DNA Polymerase Deep Vent_{R}®, DNA PolymeraseDeep Vent_{R}® (exo−) DNA Polymerase E. coli DNA, Polymerase I, Klenow Fragment DNA Polymerase I, Klenow Fragment, 3′→5′ exo⁻LongAmp® Taq DNA, PolymeraseM-MuLV Reverse TranscriptaseOneTaq™, DNA PolymeraseOneTaq™ Hot Start, DNA PolymerasePhusion® High-Fidelity, DNA PolymeraseSulfolobus DNA, Polymerase IVT4 DNA PolymeraseT7 DNA PolymeraseTaq DNA, PolymeraseTherminator™ DNA, PolymeraseTherminator™ II, DNA PolymeraseTherminator™ III, DNA PolymeraseTherminator™ γ, DNA, PolymeraseVent_{R}® DNA, PolymeraseVent_{R}® (exo−), DNA Polymerase; Fermentas: Bsm DNA Polymerase, Large Fragment, Pfu DNA Polymerase, Taq DNA Polymerase (native), Taq DNA Polymerase (recombinant), DreamTaq™ DNA Polymerase new, DreamTaq™ Green DNA Polymerase, DNA Polymerase I, Klenow Fragment, Klenow Fragment, exo−, phi29 DNA Polymerase, T4 DNA Polymerase, T7 DNA Polymerase, Terminal Deoxynucleotidyl Transferase (TdT), AMV Reverse Transcriptase, M-MuLV Reverse Transcriptase, Maxima® Reverse Transcriptase, RevertAid™ H Minus Reverse Transcriptase, RevertAid™ Premium Reverse Transcriptase, RevertAid™ Reverse Transcriptase Maxima® Hot Start Taq DNA Polymerase, TrueStart™ Hot Start Taq DNA Polymerase.
B. The behavior of a specific DNA polymerase when it encounters DNA damage on the template strand is a major determinant of the sensitivity and specificity of the assay. We have observed 3 types of behavior (see FIG. 1D): Stop (S), corresponding to a lesion-dependent replicative arrest immediately opposite or one base before the damaged nucleotide; Stop with Misincorporation (SM), corresponding to a lesion-dependent replicative arrest with nucleotide misincorporation opposite to the damaged base; and Lesion Bypass with Misincorporation (LBM), corresponding to a lesion-dependent misincorporation opposite to the damaged base without replicative arrest. LBM is a type of data not identified by other polymerase based assays.
C. Use of specific ions and ion concentrations in the primer extension step.
D. Optimization of primer-extension performance, through several steps including careful design and testing of oligos and adjustment of polymerase units to the complexity of the DNA being screened. More specifically, oligos should be chosen so that use with any other oligo in any other PCR steps produces a dimer formation of a delta G of more than −10 kcal/mole as determined by oligonalyzer at, for example, www.idtdna.com/analyzer/Applications/OligoAnalyzer/(IDT). Oligos should not end in a C or a G in the 3′ end.
E. Adjustment of divalent ion conditions and DNA polymerase concentration in the primer extension to target certain types of DNA damage. Behavior of polymerases at a site of damage or undamaged nucleotide depends on the divalent ion and concentration of that ion, as well as polymerase concentration used in the primer extension.
F. Elimination of unused primers.
G. Optimized wash steps after PE.

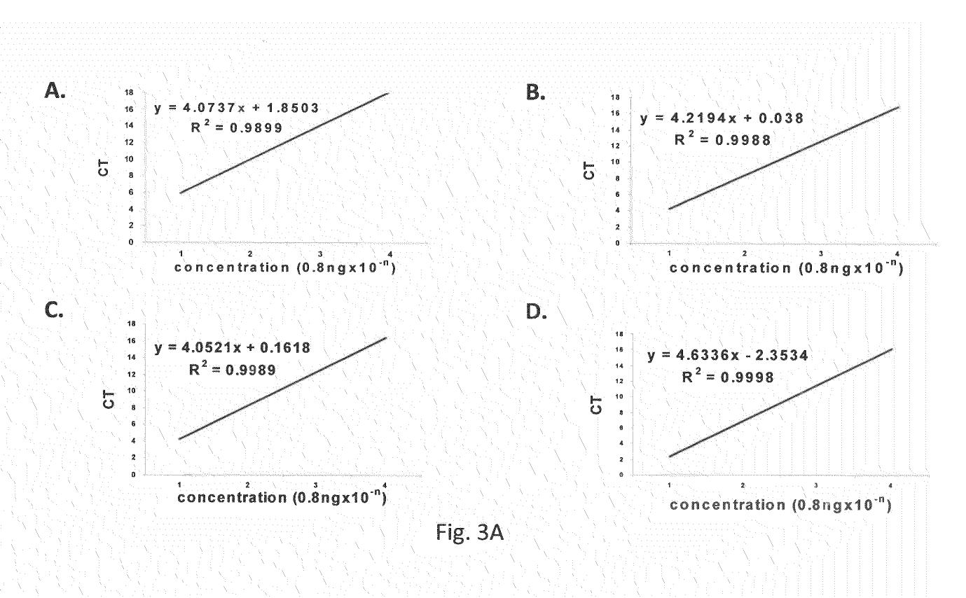

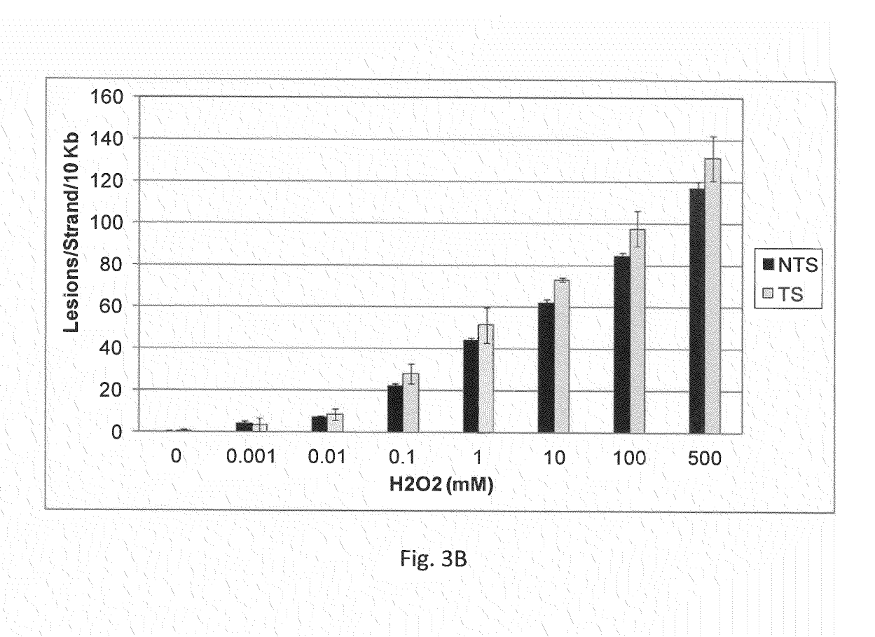

Q-PADDA
A. Use of non-cycled strand-specific primer extensions as template for Real-Time PCR.
B. Use of Real-Time PCR to quantify strand specific DNA damage.
C. Use of an internal normalization control oligo set (to control for amount of undamaged template present).
D. Optimization of the PCR conditions for the different fragments (to achieve similar amplification efficiencies required to compare different amplicons). For q-PADDA, for each PCR set, the PCR should be in the linear range (e.g., as shown in FIG. 3A). Additionally, in order to ensure the absence of nonspecific amplification, the real-time PCR raw data needs to be analyzed to make sure there is not more than a single product undergoing exponential increase. Finally, the PCR product should be run on an agarose gel and only one band of the desired size should be observed.
E. Use of other quantification systems such as Bio-Rad's digital droplet PCR system and Taqman probes for greater specificity and absolute quantification.

F-PADDA
A. Use of non-cycled strand-specific primer extensions.
B. Use of a highly efficient single-strand DNA ligase to ligate EPs to an adapter (e.g., circligase ssDNA ligase)
C. Adapter primer may be modified to facilitate ligation to EPs (phosphoryl group at the 5′-end), to prevent self-ligation (dideoxy-C at the 3′-end), and to prevent exonucleolytic digestion (phosphorothioate bonds between the last four nucleotides at the 3′ end).
D. An oligo complementary in the 3′ end to the gene-specific oligo used in the primer extension may be used in the single-strand ligation reaction to prevent non-specific ligation of any residual gene specific oligo 1 to the adapter primer.
E. For f-PADDA, and when determining the correct oligo setup, PCR products with each setup (oligo set, ions, polymerase, polymerase concentrations and temperature used in primer extension and high fidelity PCR), should be run on an agarose gel and a clean band should be observed with little or no smearing (resulting from non-specific amplification and/or heterodimer or homodimer formation by the oligos). It also may be necessary to order oligos in the 3′ end containing 2-6 phosphorothioate linkages.
F. After ligating EPs to an adapter primer, f-PADDA can be performed via two methods: a “cloning” and a “dilution” method.
G. The “cloning” method is a major advancement towards DNA mapping compared to all PCR based methods performed in the past, as it provides for the first time a highly sensitive method to map endogenous DNA damage.
G.1. PCR amplification of adapter-ligated EPs (mixture of fragments of different sizes and amounts).
G.2. Use of highly efficient cloning system (CLONEJET PCR cloning Kit, Fermentas).
G.3. Use of traditional vectors for PCR cloning requires transformation in E. coli and subsequent colony PCR to individually amplify each ligated-PE before sequencing can be performed. Nevertheless, these steps had never been applied to DNA damage detection prior to the present invention. Additionally, they provide higher sensitivity to detect DNA damage than previous PCR based methods while avoiding the use of radioactivity required by most PCR based methods.
H. The “dilution” method (which is more rapid than the “cloning” method), allows the amplification of individual primer extensions on a real-time PCR for the purpose of mapping DNA damage. This provides a high-throughput version of f-PADDA while avoiding possible bias due to exponential amplification and cloning of a mixture of fragments of different sizes and amounts.
H.1. Dilution of adapter ligated EP's to achieve one EP per well.
H.2. Use of Real-Time High Fidelity PCR amplification of ligated EP's.
H.3. Optimization of the PCR conditions for the different sets of primers is essential. More specifically, oligos should be chosen so that use with any other oligo in any other PCR steps produces a dimer formation of a delta G of more than −10 kcal/mole as determined by oligonalyzer, for example at www.idtdna.com/analyzer/Applications/OligoAnalyzer/(IDT). Oligos ideally should not end in a C or a G in the 3′ end.
H.4. Use of specific ions and ion concentrations in PCR.
H.5. All wells originating a product can be directly processed for sequencing.
H.6. Allows detection of lesions at the same ratio as the pre-set ratio, does so within a few hours, and does not require cloning and transformation.

In one embodiment of the presently disclosed and claimed inventive concepts, PADDA screens a specific DNA region for endogenous base damage by performing a single non-cycled primer-extension (see FIG. 1A) using nanogram (or less) amounts of DNA, a 5′-tagged primer (e.g., 5′-biotin-tagged primer) and a highly sensitive DNA polymerase (e.g., Vent exo−). The non-cycled primer-extension method contrasts with conventional PCR assays which rely on multiple-cycle primer-extension reactions. The method of the presently disclosed and claimed inventive concepts generate a pool of highly specific tagged extended products (e.g., tagged with biotin), each product derived from a single DNA molecule and strand (see FIG. 1A). Each extended product has a stop, which represents replicative arrest by a damaged nucleotide. Therefore, when derived from genomic DNA, each extended product represents DNA damage at the single-strand, single-gene and single-cell level. Vent exo− is used in this embodiment, instead of the currently used Sequenase (13) or Taq DNA polymerase (14), due to its reported superior sensitivity to detect DNA damage (21) and efficiency during primer-extension (22). After the primer-extension, the extended products are purified and captured on streptavidin-coated paramagnetic beads (when biotin-tagged) and are released from genomic DNA. This highly purified pool of extended products can be used directly for real-time PCR analysis, allowing high-throughput reliable strand-specific DNA damage quantification (q-PADDA) within 5 h. Alternatively, the extended products in the purified pool can be ligated to a chemically modified oligonucleotide-adapter using a highly efficient single-strand DNA ligase. This recognition sequence at the end of the extended product allows for fingerprinting analysis (f-PADDA) of damage and repair at the single-nucleotide level by revealing the places on sequence template where polymerase extension was stopped. Misincorporations on the sequence indicate sites of damage that were bypassed with error by the polymerase. A small number of those will represent polymerase errors (e.g., for Vent exo− this number is 1.9×10⁻⁴).

### EXAMPLES

While the presently disclosed and claimed inventive concepts will now be described in connection with certain preferred embodiments in the following examples so that aspects thereof may be more fully understood and appreciated, it is not intended to limit the presently disclosed and claimed inventive concepts to these particular embodiments. On the contrary, it is intended to cover all alternatives, modifications and equivalents as may be included within the scope of the presently disclosed and claimed inventive concepts as defined by the appended claims. Thus, the following examples, which include preferred embodiments will serve to illustrate the practice of the invention, it being understood that the particulars shown are by way of example and for purposes of illustrative discussion of preferred embodiments of the presently disclosed and claimed inventive concepts only and are presented in the cause of providing what is believed to be the most useful and readily understood description of formulation procedures as well as of the principles and conceptual aspects of the presently disclosed and claimed inventive concepts.

Material and Methods

Yeast Strains

The strains of the yeast Saccharomyces cerevisiae used in this study were previously reported (11): SJR751 (MATα ade2-101oc his3Δ200 ura3ΔNco lys2ΔBgl leu2-R) and its isogenic derivative SJR867 (MATαade2-101oc his3Δ200 ura3ΔNco lys2ΔBgl leu2-R ntg1Δ::LEU2 ntg2Δ::hisG apn1Δ1::HIS3). SJR751 and SJR867 are referred to as wild-type (WT) and BER defective (BER⁻) strains, respectively. For DNA damage assessment, yeast cells were grown, in the dark, in liquid YPD media to approximately 2×10⁷ cells/ml (exponential phase) or 5×10⁸ (stationary phase).

DNA Extraction and Quantification

To reduce levels of artifactual DNA damage, samples were kept in low light conditions, handled with gentle pipetting, and never vortexed throughout DNA extraction procedures. 2×10⁹ yeast cells were harvested by centrifugation, washed in H₂0, resuspended in 1 ml spheroblast buffer with 200 U Zymolyase (Zymoresearch, Orange, Calif.) and incubated at 37° C. for 2 h. Genomic DNA was then extracted with OXITEK DNA isolation kit (ZeptoMetrix Corp., Buffalo, N.Y.) to minimize artifactual oxidative DNA damage. DNA was then resuspended in TE buffer and stored at 4° C. To assure precise DNA measurement, DNA concentration was measured using the QUBIT Fluorometer (Invitrogen, Carlsbad, Calif.) and QUANT-IT dsDNA HS reagents.

Primer-Anchored DNA Damage Detection Assay (PADDA)

A single non-cycled primer-extension reaction in the region of interest was performed to screen for DNA damage. The oligonucleotides (SEQ ID NOs. 1-52) used in these experiments are listed in Table 2. It will be understood that the presently disclosed and claimed inventive concepts are not limited to these oligonucleotides. For damage detection in synthetic DNA, we prepared a 22.8 μl primer extension reaction containing 1× Thermopol buffer (NEB, Ipswich, Mass.), 0.2 mM each dNTP (Fermentas, Glen Burie, Md.), 20 pmol of a 5-biotin-tagged primer, and 20 pmol of a 64 base template containing either a synthetic abasic or 8-OxoG lesion, along with a control (undamaged oligo). To generate a pool of biotin-tagged extended products (FIG. 1A), the mix was incubated at 94° C. for 3 min, held at 85° C. to add 0.08 U of Vent exo− (NEB), and then incubated at 58° C. for 2 min (annealing), and 75° C. for 2 min (extension). For damage detection in genomic DNA, we used 500 ng of S. cerevisiae genomic DNA, 0.8 U of Vent exo−, and 2 pmol of a 5-biotin-tagged gene specific primer. A sample containing all reagents except Vent exo− was used as a negative control for all experiments. The non-cycled primer-extension contrasts with the multiple-cycle primer-extension reaction of previous assays, and generates a pool of highly specific biotin-tagged extended products (EPs), each of them derived from a single DNA molecule and strand (FIG. 1A). The use of a 5-biotin-tagged sequence specific primer allows for subsequent steps aimed at reducing the background of the technique. Vent exo−, a truncated form of a native DNA polymerase (Vent, NEB), was chosen for this assay instead of the currently used Sequenase (13) or Taq DNA polymerase (14), because of its reported high sensitivity to detect DNA damage (21) and primer-extension efficiency (22-24). To optimize primer-extension performance, Vent exo− units were adjusted to the complexity of the DNA being screened (22).

TABLE 2
Oligonucleotides containing a single damaged base and primers used to screen for damage.

| SEQ ID | Oligonucleotide | | |
|---|---|---|---|
| NO: | Name | Sequence 5′-3′ | Analysis |
| 1 | Undamaged | CCACTCACCGTGCACATAACAGACTTGGCTGTCCCAGACTG | f-PADDA |
| | oligo | CAGGAAGCCCAGGTGGAAGCCAT | |
| 2 | 8-Oxo-dG oligo | CCACTCACCNTGCACATAACAGACTTGGCTGTCCCAGACTGC | f-PADDA |
| | | AGGAAGCCCAGGTGGAAGCCAT | |
| 3 | Abasic site oligo | CCACTCTCCATGCACATAACAGACTTGGCTCACCNTGCACTC | f-PADDA |
| | | AGGAAGCCCAGGTGGAAGCCAT | |
| 4 | Thymine Glycol | CCACTCACCGNGCACATAACAGACTTGGCTGTCCCAGACTG | f-PADDA |
| | oligo | CAGGAAGCCCAGGTGGAAGCCAT | |
| 5 | 8-oxo-dA | CCACTCTCCATGCACATAACAGACTTGGCTGTGCNCGGTGCT | f-PADDA |
| | | CAGGAAGCCCAGGTGGAAGCCAT | |
| 6 | OSP1-Biotin | Biotin-CTTACCAGGGCAACTATGGCTTCCACCTGGGCTTC | f-PADDA |
| 7 | OSP2 | CTTCCACCTGGGCTT*C*C*T | f-PADDA |
| 8 | mp53-e4- | Biotin-TEG-CTT ACC AGG GCA ACT ATG GCT TCC ACC TGG | f-PADDA |
| | 191/225-Biotin- | GCT TC | |
| | TEG | | |
| 9 | mp53-i4-Biotin- | Biotin-CAG GCT GAA GAG GAA CCC CCA AAT CTA GAC | f-PADDA |
| | 87/58 | | |
| 10 | mp53-i4-Biotin | Biotin-CAT TGA AAG GTC ACA CGA AAG ACA ACT CC | f-PADDA |
| | 44/16 | | |
| 11 | mp53-e4- | CCT GCA GTC TGG GAC AGC CAA GTC TGT T * A * T *G | f-PADDA |
| | 225/255 | | |
| 12 | mp53-i4-22/3 | CAA CTC CCC GGG GCC C*A*C* T*C | f-PADDA |
| 13 | mp53-i4-43-20 | CAT TGA AAG GTC ACA CGA AAG A*C*A* A | f-PADDA |
| 14 | mp53-i4-61-37 | CTA GAC AGA GAA AAA GAG GCA TTG *A*A*A | q-PADDA |
| 15 | mp53-e4- | CCT GCA GTC TGG GAC AGC CAA GTC TGT TAT GT | q-PADDA |
| | 225/256 | | |
| 16 | mp53-i4-311- | TCC ATG CTC AGG CTG GCC | q-PADDA |
| | 294 | | |
| 17 | hp53-biotin-i8- | Biotin-AAG GAA AGG TGA TAA AAG TGA ATC TG | F, Q-PADDA |
| | 79-54 | | |
| 18 | hp53-biotin-i6- | Biotin-GCG ACA GAG CGA GAT TCC AT | F, Q-PADDA |
| | 459-478 | | |
| 19 | hp53-i8-56-32 | CTG AGG CAT AAC TGC ACC CTT *G*G*T *C | F, q-PADDA |
| 20 | hp53-i6-500-525 | CCT GCT TGC CAC AGG TC*T *C*C*C | f-PADDA |
| 21 | hp53-i7-292-317 | AGG ACC TGA TTT CCT TAC TGC C*T*C* T*T | q-PADDA |
| 22 | hp53-i6-502-528 | TGC TTG CCA CAG GTC TCC *C*C*A *A | q-PADDA |
| 23 | hp53-e7-35-16 | TAG TTG TAG TGG ATG GTG GTA CAG T | q-PADDA |
| 24 | sc-CAN1-1185- | CGTTGGTTCCCGTATTTTATTTGGTCTATC | q-PADDA |
| | 1214 | | |
| 25 | sc-CAN1-740- | GTATGGTTTGTGGTGCTGGGGTTACCGGCCCAGTTGGATTC | q-PADDA |
| | 780 | | |
| 26 | sc-CAN1-Biotin- | Biotin-CTCTGGTACAAAGGTTTTGCCACATATCTTCAACGCTG | q-PADDA |
| | 1104-1141 | | |
| 27 | sc-CAN1-1117- | GTTTTGCCACATATCTTCAACGCTGTTATCT*T*A*A*C | q-PADDA |
| | 1151 | | |
| 28 | sc-CAN1-1209- | ACCAAATAAAATACGGGAACCAACGTAAATATTTGAA | q-PADDA |
| | 1173 | | |
| 29 | sc-CAN1-1769- | GCTACAACATTCCAAAATTTGTCCCAAAAAGTC | q-PADDA |
| | 1737 | | |
| 30 | probe sc-can1 | 56-FAM-TTGGTTCCCGTATTTTATTTGGTCTATCA/36-TAMSp | q-PADDA |
| | 1182-1215 | | |
| 31 | LNA probe sc- | 56-FAM/T + TG + GC + TC + CTAA + AT + TCC/3BHQ_1 | q-PADDA |
| | can1 1225-1240 | | |
| 32 | Sc-CAN1 687- | GGTCGCTTCCATCAA | q-PADDA |
| | 701 | | |
| 33 | Sc-CAN1 1121- | TGCCACATATCTTCAAC | q-PADDA |
| | 1137 | | |
| 34 | Sc-CAN11258- | CTT TGG TGG TCC TTG A | q-PADDA |
| | 1241 | | |
| 35 | Sc-CAN11678- | CGA CAT CTC CAA TCT TC | q-PADDA |
| | 1662 | | |
| 36 | sc-can1-1262 | CCACCTTTGGTGGTCCTTGA | q-PADDA |
| | 1244 | | |
| 37 | sc-can1 1161- | TTCTGCCGCAAATTCAAATATT | q-PADDA |
| | 1182 | | |
| 38 | sc-can1-661-683 | AAATATTACGGTGAATTCGAGTT | q-PADDA |
| 39 | sc-can1-1126- | CATATCTTCAACGCTGTTATCTTAA | q-PADDA |
| | 1150 | | |
| 40 | sc-can1-1239- | GAATTTAGGAGCCAACTTGTT | q-PADDA |
| | 1218 | | |
| 41 | sc-CAN1- | GCT ACA ACA TTC CAA AAT TTG TCC CAA AAA GTC | q-PADDA |
| | 1769/1737 | | |
| 42 | Adapter | Phos- | f-PADDA |
| | | AGGCATGAGAACCATCTGCAGTACGTCCTGGTCAG*C*A*G*- | |
| | | ddC | |
| 43 | Adapter | 5Phos/AAAAAGGACAAACCGACGGCAGAAAACCC*A*G*G*A/ | f-PADDA |
| | | 3ddC | |
| 44 | Adapter | Phos/AGG ATA TGG CCT ACG ATC AGC AGT ACG TCG TGC | f-PADDA |
| | | T*C*A* G*C*/ddC | |
| 45 | c-adapter | CCAGGACGTACTGCAGATGGTTCTCATGC | f-PADDA |
| 46 | C_adapter | GTCCTGGGTTTTCTGCCGTCG*G*T*T*T | f-PADDA |
| 47 | C_adapter | CAC GAC GTA CTG CTG ATC GTA GGC CAT ATC C | f-PADDA |
| 48 | pJET1-284-314 | GTAGCATCACGCTGTGAGTAAGTTCTAAACC | sequencing |
| 49 | pJET1-631-602 | GGTTCCTGATGAGGTGGTTAGCATAGTTC | sequencing |
| 50 | sc-CAN1-Biotin- | Biotin-CTGCAATGTATGGAACACCACCTTTGG | f, q-PADDA NTS |
| | 1279-1253 | | |
| 51 | sc-CAN1-1277- | GCAATGTATGGAACACCACCTTTGGTGGTC*C*T*T*G | f-PADDA NTS |
| | 1244 | | |
| 52 | sc-CAN1-1251- | GGTCCTTGACAGGAATTTAGGAGCCAAC | q-PADDA NTS |
| | 1224 | | |

Abbreviations used in oligos-Biotin-TEG = Biotin-tetraethyleneglycol, Phos = phosphate, ddC = dideoxy C, * = phosphorothioate linkages. -TS = transcribed strand; NTS = non-transcribed strand. N in SEQ ID NO: 2 is 7,8-dihydro-8-oxo-2′-deoxyguanosine (8-oxo-dG). N in SEQ ID NO: 5 is 7,8-dihydro-8-oxo-2′-deoxyadenosine (8-oxo-dA). N in SEQ ID NO: 4 is 5R,6S-dihydroxy-5,6-dihydrothymine (thymine glycol). N in SEQ ID NO: 3 is dSpacer tetrahydrofuran analog. Lesion positions indicated as N were synthesized by Keck Facility (Yale University) and cartridge purified. The phosphoramidites for these oligos were purchased from Glen Research. OSP1-Biotin, sc-CAN1-Biotin-1279-1253, sc-CAN1-Biotin-1104-1141 and Adapter were synthesized by IDT and HPLC purified. Probe oligos were ordered from IDT and HPLC purified. (+) indicates a locked nucleic acid in the base to the right. The remaining primers were synthesized by IDT and ordered standard desalted. Forward primers are represented in the oligonucleotide name by ascending position numbers (e.g., 459-478 in SEQ ID NO: 18). Reverse primers are represented in the oligonucleotide name by descending position numbers (e.g., 79-54 in SEQ ID NO: 17).

After the single primer-extension reaction, to degrade unused primers, the mix was incubated with Exonuclease I (NEB) as per manufacturer's recommendation. Next, the reaction was held for 10 min at 94° C. to degrade Exonuclease I and denature the DNA, facilitating the release of desired extension products from genomic DNA. The reaction was further purified using the Qiaquick Nucleotide Removal Kit (Qiagen, Valencia, Calif.) to eliminate biotin-mononucleotides and products smaller than 17 bases generated by Exonuclease I digestion.

The purified EPs were captured with biotin-binding, streptavidin-coated paramagnetic beads (0.2 mg DYNABEADS M-270 Streptavidin, Invitrogen) and washed in B&W buffer as per manufacturer's recommendation. To further remove possibly contaminating genomic DNA, samples were incubated for 5 min with 1 ml of 0.5 M NaOH, spun briefly and exposed to a magnetic field to facilitate supernatant removal. Each sample was then washed twice with 200 μl of 2× B&W buffer to assure no traces of NaOH remained. After this step, extended products were either processed for fingerprinting (mapping) nucleotide damage (f-PADDA) or for high-throughput damage quantification (q-PADDA).

Fingerprinting Strand-Specific DNA Damage (F-PADDA)

For the purpose of mapping strand-specific nucleotide damage (f-PADDA), the 3′-end of the highly purified extended products was attached to the 5′-end of a chemically modified adapter-primer using Thermophage single-stranded DNA ligase (Prokaria, Reykjavik, Iceland) [Currently Circligase I from Epicentre, Madison, Wis.]. Thermophage was chosen for this reaction because its efficiency for single-strand ligation is higher than that of T4 RNA ligase (25) used in some PCR-based assays. The adapter-primer was phosphorylated at the 5′-end to facilitate ligation, possessed a dideoxy-C at the 3′-end to prevent self-ligation, and contained phosphorothioate bonds between the last four nucleotides at the 3′ end to prevent exonucleolytic digestion. Purified extended-products were first washed with 20 μl of 1× Thermophage ssDNA ligase buffer and then resuspended in 3.7 μl of 1× Thermophage ssDNA ligase buffer. The ligation was performed as recommended by Prokaria except 1.5 μM adapter and 10 U ssDNA ligase in a final 10 μl volume were used under the following conditions: 55° C. for 1 h, 65° C. for 15 min, and 70° C. for 15 min. Then, samples were spun briefly and the supernatant removed as before in the presence of a magnet. The adapter-ligated extended-products were washed with 1 ml of 2× B&W buffer, and then incubated with 1 ml of 0.5 M NaOH for 5 min to completely remove free adapters and non-specifically bound DNA. Finally, the supernatant was discarded and the bound products were washed with 200 μl of 2× B&W buffer. The adapter-linked extended-products pool was then washed with 20 μl of 1× Phusion HF PCR buffer and amplified for 35-cycles using Phusion Hot-Start DNA Polymerase (Finnzymes), an oligonucleotide complementary to the adapter-primer and a nested gene-specific primer according to the manufacturer's instructions. Phusion Hot-Start DNA Polymerase has the highest available accuracy (error rate=4.4×10⁻⁷) and generates blunt-end products. After PCR amplification, the supernatant was collected under a magnetic field for use in cloning (CLONE JET PCR cloning kit, Fermentas) and transformation following standard procedures. This cloning strategy yields 99% of clones positive for a cloned insert. For amplification of single clones, individual bacterial colonies were randomly selected and directly used for colony PCR using primers flanking the plasmid insert under standard conditions. PCR products were purified with Qiagen PCR purification kit, sequenced on an ABI 3730 48-capillary sequencer and analyzed using SEQUENCHER (Gene Codes Co.). We assayed at least two DNA samples for each unrepaired genotype and time point and analyzed a total of 222 clones from 12 independent experiments. A minimum of 20 randomly selected clones were analyzed for each genotype, phase of growth (exponential versus stationary) and repair status (repaired versus unrepaired). Primer extension after in vitro repair was assessed as for unrepaired genomic DNA by sequencing random clones obtained from BER⁻ cells in stationary phase. To assess PADDA's sensitivity in the presence of different types of damage, 20 μmol total of abasic and 8-oxodA lesion oligos were combined in a pre-set ratio of 1:1 and 1:10 ratio, and used as substrates for f-PADDA. Samples were processed as above, except the adapter-ligated extended-products were diluted (approximately 1×10⁻⁷) with the aim of obtaining one single molecule per well of a 96 well PCR plate. Reactions were carried out in an IQ5 Real-Time PCR detection system in a 25 μl final volume with Phusion HF PCR buffer, 1:75,000 dilution SYBR Green I (Invitrogen), 0.8 mM total dNTPs (Fermentas), 0.7 μM each oligo, and 0.4 units Phusion™ Hot Start II DNA Polymerase under the following conditions: 98° C., 30 sec; 75 cycles (98° C., 10 sec; 64° C., 15 sec; 72° C., 10 sec). Those wells that amplified, as determined by the level of fluorescent signal per well, were purified using a PCR purification kit (Qiagen) and sequenced.

In Vitro DNA Repair

In vitro repair of endogenous DNA damage was performed using the PreCR repair mix (NEB). The PreCR DNA repair kit contains a cocktail of enzymes [Taq DNA Ligase, Endonuclease IV, Bst DNA Polymerase, Fpg, Uracil-DNA Glycosylase (UDG), T4 PDG (T4 Endonuclease V) and Endonuclease VIII] that have been reported to repair a broad range of spontaneous and induced DNA lesions (79-81), including: apurinic/apyrimidinic sites, 8-oxo-guanine, deaminated cytosine, thymine dimers, dU and nicks (82,83) and www.neb.com). The PreCR Repair kit will not repair fragmented DNA (www.neb.com). DNA repair reactions were performed in a 20 μl reaction volume with 1× Thermopol buffer (NEB), 0.1 mM each dNTP (Fermentas), 1.25 mM NAD⁺ (NEB), 1 μl PreCR repair mix and 500 ng genomic DNA. Control reactions included all reagents but the PreCR repair mix. Samples were protected from light and incubated under the following conditions: 37° C., 1 h; 4° C., 1 h.

Statistical Analysis

Data were compiled in EXCEL (Microsoft) files and statistical analyses were performed using SAS STAT Version 9.1 (SAS Institute Inc.). Proportions were compared using Fisher's Exact Tests. Independent means were compared using t-tests whose degrees of freedom were corrected, when appropriate, for inequality of variance.

Each length of extended product equals the length of the extension performed by Vent exo−, and was determined as the distance (expressed in bases) between the 3′ end of the gene-specific primer 1 and the stop position. We compared the mean length of the extended products in an analysis of variance that simultaneously modeled extended products on genotype, growth phase, and on whether the DNA samples were repaired, or not, in vitro before processing. When examination of residuals from the original model indicated that distributions of extended products were skewed, we performed the analysis of variance on log-transformed values of extended products. This modification ensured that hypothesis tests and estimates of confidence intervals were valid and trustworthy.

The rate of misincorporation per base was calculated for each genotype as the total number of lesion bypass with misincorporation (LBMs) and stops with misincorporation (SMs) divided by the total length of the extended products for that genotype. We compared rates of misincorporation using a logistic regression model. The model estimated 95% confidence intervals on genotype-specific and growth phase-specific misincorporation rates, the lower limits of which we compared to the published Vent exo− error rate (27) of 1.9×10⁻⁴.

To determine whether damage was detected non-randomly in a region of interest on the CAN1 gene, we calculated for each base in the region the conditional probability that the polymerase found damage at that base, given that the polymerase had not previously ‘stopped’ and was, therefore, available to detect damage at that base. A Chi-square goodness of fit test compared this set of conditional probabilities with the uniform probabilities that are expected if damage detection was a purely random process. Rejection of the test's null hypothesis suggested that damage detection was non-random. After verifying that primers detected damage non-randomly, we focused our analysis to the CAN1 ORF (CAN1, X03784) nucleotides 1180-1215, a region where frequent mutations were reported (28,29). We used Fisher's Exact Test to assess whether the damaged nucleotides detected by f-PADDA were associated with those previously reported to be the sites of mutations.

In Vitro and In Vivo Induced DNA Damage Data:

We quantified induced DNA damage after in vitro and/or in vivo exposure to a dose escalation of H₂O₂ (1 μM to 500 mM) and methyl methanosulfonate (MMS) (1 mM to 1 M). For in vitro assays, a 1,750 bp fragment of the CAN1 gene was amplified by PCR and cloned into the pJET1.2 vector (Fermentas, Glenn Burie, Md.) using standard protocols. Plasmid DNA was sequence verified, extracted using CsCl and dialyzed overnight against 500 ml H₂O. Five μg of dialyzed DNA were treated with H₂O₂ in the presence of 0.3 M sucrose and 100 μM Fₑ²⁺ as described (84), or with MMS in water (85). Treated DNA was recovered by ethanol precipitation. For in vivo induced DNA damage assays, BER− cells in logarithmic phase were treated with varying doses and times of MMS as described (85). For a control, cells were treated with water in place of MMS. Genomic DNA was extracted as described above, except MMS concentration was kept constant during spheroplasting. Additionally, proteinase K treatment was performed at 37° C., as after MMS treatment incubation at 55° C. has been shown to cause double stranded DNA breaks (85). Control samples were processed as treated samples except water was added in place of the specific genotoxic. Experiments were repeated at least in triplicate. For high-throughput damage quantification, the highly purified streptavidin bound extended products were re-suspended in 50 μl TE and amplified by Real-Time PCR using one of 2 Real-Time PCR detection Systems: IQ5 Real-Time PCR detection System or Qx100 digital droplet PCR system.

For the IQ5 Real-Time PCR detection System using Sybr Green, reactions were carried out in an in a 25 μl final volume with PCR buffer (40 mM Tricine-KOH (pH 8.0), 16 mM KCl, 3.5 mM MgCl₂, 3.75 μg/ml bovine serum albumin), 1:75,000 dilution SYBR Green I (Invitrogen), 0.8 mM total dNTPs (Fermentas), 0.7 units JUMPSTART Taq polymerase (Sigma), 0.32 μM each oligo, and 1/32 of total extended product pool. Amplification was monitored and analyzed by measuring the intercalation of the fluorescent dye to double-stranded DNA according to the manufacturer's instructions. To quantify damage on each strand of the yeast CAN1 gene, two fragments of different lengths located in the same genomic region were amplified. The long fragment (513 to 628 bases) was used to assess damage quantification. The short fragment (67 to 68 bases), representing undamaged DNA, was used as an internal normalization control. The PCR conditions for the different fragments were optimized to achieve similar amplification efficiencies required to compare different amplicons. All products were amplified under the following conditions: 95° C., 3 min; 40 cycles (95° C., 15 s; 63° C., 40 s). Each sample was assayed in at least three independent experiments, each with at least four wells per sample, from three separate yeast cultures and DNA extractions. To assess the relative accumulation of damage per strand, data was normalized to the respective strand in the unrepaired DNA obtained from WT cells in exponential phase. To compare lesion rate between DNA strands, data was normalized to the respective strand of in vitro repaired DNA obtained from WT cells grown in exponential phase. DNA lesion frequency was estimated using the Poisson equation n=−LN(o), where “o” is the fraction of full length fragments and “n” is the average DNA lesions per fragment.

The versatility of PADDA was also documented in the IQ5 Real-Time PCR detection System using a fluorescent probe instead of SYBR Green. Essentially, a probe is designed that binds to the undamaged control template of PADDA primer extensions. Presence of an undamaged template will thus result in the release of fluorophore after amplification by both the undamaged control oligos as well as test template oligos. For this purpose, 0.9 uM each forward and reverse oligo; 0.26 uM probe; ddPCR mix from Bio-rad (2× ddPCR PROBE SUPERMIX) were used under the following conditions: 95° C., 10 min; 50 cycles (94° C., 30 sec; 56° C., 1 min; 72° C., 1.5 min). Fluorescence was continuously monitored versus cycle numbers as per IQ5 Real-Time PCR detection system protocol. The relative amount of damaged template was derived using the 2^{-ΔΔCT} method (26) using a threshold of 40. Damage for this method is quantified as per damage using q-PADDA with the SYBR Green method.

For the Real-Time Qx100 digital droplet detection System (ddPCR), 0.9 uM each forward and reverse oligo; 0.26 uM probe; and digital-droplet PCR mix (2× ddPCR PROB SUPERMIX, Bio-Rad) were used under the following conditions: 95° C. 10 min; 75 cycles (94° C. 30 sec; 56° C., 1 min; 72° C., 1.5 min); 98° C., 10 min. This method essentially distributes DNA templates into thousands of individual droplets, which will undergo RT-PCR under standard Taqman conditions in the presence of a labeled probe. Droplets containing template DNA will thus released fluorescent dye after PCR amplification. These droplets are then spread on an imager that quantifies the number of droplets containing released fluorophore and thus template DNA. By applying this approach to ddPCR, we are able to calculate the number of primer extension molecules per strand. To validate this approach, we employed a probe and used a Qx100 ddPCR system. By amplifying two fragments of different lengths located in the same genomic region this approach provides absolute quantification of primer extensions that reach a given length. This prevents the need to normalize the amount of damage in a DNA template to in-vitro repaired DNA when one desires to know the overall strand specific levels of DNA damage. As ddPCR quantifies the number of templates present that reach a given length, damage is detected for each primer extension pool in the ddPCR setup of q-PADDA by dividing the number of test templates by undamaged control templates. Doing so provides a percentage of a pool of templates that have at least one event of DNA damage that blocks the primer extension between oligos used for the undamaged control (approximately 100 bases) and the test template (about 500-1000 bases).

### Results

### Example 1

### Validation of PADDA on Artificial Templates Containing Oxidative DNA Lesions

As represented schematically in FIG. 1A-D, PADDA relies on the principle that the presence of DNA damage on the template changes the polymerase replicative rate leading to lesion bypass with or without misincorporation, or to lesion-dependent replicative arrest before or opposite to the damaged base. Represented in FIG. 1A is a single non-cycled primer extension performed with a 5′-biotin-tagged primer and Vent exo− DNA polymerase which identifies damaged nucleotides (inverted triangles), and generates a pool of highly specific biotin-tagged extended products (also referred to herein as “extended products,” or “EPs,”), each of them derived from a single DNA molecule and strand. Each extended product has a stop, which represents replicative arrest by a damaged nucleotide, a nick or random polymerase stalling. After several purification steps that include the use of biotin-binding, streptavidin-coated, paramagnetic beads, the strand-specific, highly purified, biotin-bound extended products can be used directly for real-time PCR analysis, allowing high-throughput, reliable strand-specific DNA damage quantification (“q-PADDA”) to be obtained within 5 h (FIG. 1B). Alternatively, the purified pool of EPs can be ligated to a chemically modified oligonucleotide-adapter using a highly efficient single-strand DNA ligase, allowing for fingerprinting analysis (“f-PADDA”) of damage and repair at the single-nucleotide level to be obtained in less than 2 days (FIG. 1C).

As shown in the schematic representation of q-PADDA (“Quantification” PADDA) in FIG. 1B, q-PADDA allows for strand specific determination of damage. This damage can either be relative to a control to assess only accumulation of damage for a particular condition, or relative to a control that has been repaired by an in vitro DNA repair kit (PreCR repair kir, NEB). By repairing the template DNA in-vitro and normalizing the data to this repaired DNA, overall damage levels per strand and within genotypes can be determined. For high-throughput damage quantification, the highly purified streptavidin-bound extended products (produced as in FIG. 1A) are re-suspended in TE and amplified by Real-Time PCR.

We have documented the use of the assay in two different Real-Time PCR approaches: (a) the most classic Real-Time PCR approach, which amplifies the template DNA as a pool of molecules and uses either the intercalation of fluorescent dye to double-stranded DNA or quenching/release of a fluorescent DNA probe; this is the standard Real-Time PCR approach; reactions are carried out in an IQ5 Real-Time PCR detection System and amplification is monitored and analyzed by measuring the intercalation of the fluorescent dye to double-stranded DNA or probe release according to the manufacturer's instructions; Fluorescence is continuously monitored versus cycle numbers as per Bio-Rad IQ5 Real-Time PCR detection system protocol. The relative amount of damaged template is derived using the 2^{-ΔΔCT} method (74). This method is commonly used for Real-Time PCR to determine gene expression and it essentially measures a difference in number of templates compared to a control. (b) One of the most recently introduced PCR systems for the absolute quantification of DNA molecules, the Bio-Rad Qx100 digital droplet PCR system; most systems that focus on the absolute quantification of DNA molecules use a specific DNA labeled probe. Additionally, in the innovation of the Qx100 digital droplet PCR system resides in the separation of DNA molecule templates into individual droplets. It is the distribution of a given template between thousands of droplets per sample that will determine the frequency of the PCR amplification and will reveal the absolute quantification of DNA molecules.

For the purpose of quantifying DNA damage, the Real-Time PCR methods require the amplification of two fragments of different sizes for a given genome area. The long fragment (approximately 600-1000 bases) is used to assess damage quantification. The short fragment (60 to 100 bases, included within the large fragment), representing undamaged DNA, is used as an internal normalization control. The PCR conditions for the different fragments must be optimized to achieve similar amplification efficiencies required to compare different amplicons. To assess the relative accumulation of damage per strand, data is normalized to the respective strand in the unrepaired DNA. To compare lesion rate between DNA strands and within genotypes, data is normalized to the respective strand of in vitro repaired DNA obtained from WT cells (or a cell or template with little damage) for the classical RT PCR approach. For the digital droplet PCR approach, lesion rates are compared through absolute quantification of damage without the need to normalize to in vitro repaired DNA. As shown in the schematic representation of f-PADDA (“fingerprinting” PADDA) in FIG. 1C, f-PADDA allows for mapping DNA lesions at the nucleotide level. For f-PADDA, lesions can be mapped via either a “dilution” method or a “cloning” method. Both methods require different processing steps after the ligation of a chemically modified adapter primer using a commercially available single-stranded DNA ligase. For the purpose of ligating an adapter to the EP's, the 3′-end of the highly purified extended products are attached to the 5′-end of a chemically modified adapter-primer using circligase single-stranded DNA ligase (Epicentre). The adapter-primer is phosphorylated at the 5′-end to facilitate ligation, possesses a dideoxy-C at the 3′-end to prevent self-ligation, and contains phosphorothioate bonds between the last four nucleotides at the 3′ end to prevent exonucleolytic digestion. In order to decrease potential artifacts generated by the ligation of unextended biotinylated oligos to the adapter-primer, an oligo complementary in the 3′ end to the gene-specific oligo used in the primer extension may be used in the single-strand ligation reaction. This oligonucleotide that is complementary to the oligo used in the primer extension essentially produces a double stranded end to the un-extended biotinylated primers and prevents ligation to the single stranded adapter-primer. After ligation to the adapter, adapter ligated EP's are washed with 1 ml of 2× B&W buffer, and then incubated with 0.5 M NaOH for 5 min to completely remove free adapters and non-specifically bound DNA. Finally, the supernatant is discarded and the bound products are washed with appropriate buffers for either the “dilution” or the “cloning” method.

The dilution method of f-PADDA relies on diluting each adapter-ligated PE to one single molecule per well of a 96 well PCR plate. Then, using a high fidelity DNA polymerase (we use PHUSION HOT START II from Thermofisher), specific oligos, and a fluorescent DNA binding Dye in the PCR (Sybr Green I, Invitrogen), the EP's are amplified in a Real Time PCR machine. The Real Time system then determines which wells amplify (i.e. which ones contained a template EP) by measuring the level of fluorescent signal per well. Those wells that amplify are then purified with a commercial kit and sent for sequencing. If a Real Time PCR machine is not available, wells can be amplified via a traditional PCR machine and then run on an agarose gel to determine which wells contained adapter-ligated primer extension products.

In the “cloning method”, the adapter-linked extended-products pool is amplified for 35-cycles using PHUSION HOT START II DNA Polymerase (Thermofisher), an oligonucleotide complementary to the adapter-primer and a nested gene-specific primer according to the manufacturer's instructions. In the presently disclosed and claimed inventive concepts any high fidelity DNA polymerase can be used. After PCR amplification, the supernatant is collected under a magnetic field for use in cloning (CLONE JET PCR cloning kit) and transformation following standard procedures. Plasmids from individual E. coli colonies containing an insert are then amplified via colony PCR, purified and sent for sequencing.

FIG. 1D is a graph showing representative DNA sequence chromatographs identifying DNA damage position. Shown is the positional identification by f-PADDA of 8-OxoG as: Stop, Stop with Misincorporation (SM) and Lesion Bypass with Misincorporation (LBM). The damaged nucleotide is indicated either by the adapter's complementary sequence (arrow) or by the presence of a misincorporated nucleotide (base change).

To validate our novel methodology (characterized schematically in FIG. 1), we first determined the efficiency of PADDA to detect and map within synthetic oligonucleotides a single abasic site, 8-oxoguanine (8-OxoG), 8-oxoadenine (8-oxoA), or thymine glycol lesion. In conformity with established concepts that interpret the behavior of DNA polymerases when they encounter DNA damage on the template strand, we observed 3 types of data (FIG. 1D): Stop (S), corresponding to a lesion-dependent replicative arrest immediately opposite or one base before the damaged nucleotide; Stop with Misincorporation (SM), corresponding to a lesion-dependent replicative arrest with nucleotide misincorporation opposite to the damaged base; and Lesion Bypass with Misincorporation (LBM), corresponding to a lesion-dependent misincorporation opposite to the damaged base without replicative arrest. For the engineered abasic site, the designation of misincorporation was attributed every time the polymerase incorporated a nucleotide opposite to the lesion.

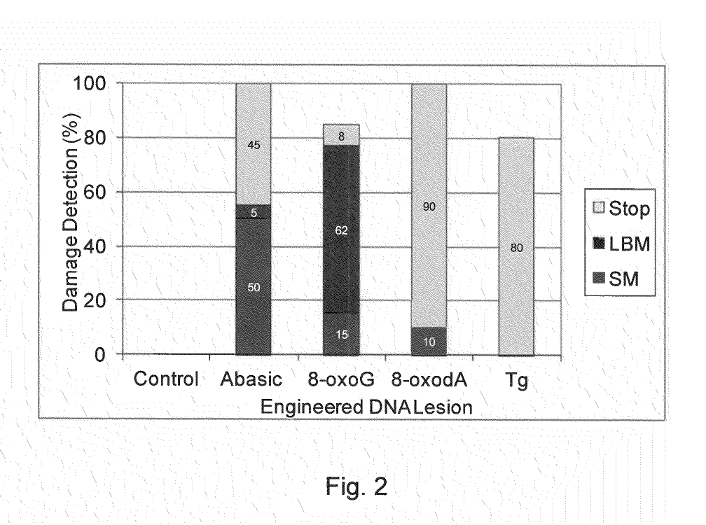

We analyzed at least 20 independent events for each oxidative lesion. Results are summarized in FIG. 2. Abasic sites were detected in 100% of the primer extensions, either as Vent exo− blocking lesions (95%) or as LBM (5%). As a blocking lesion the abasic site resulted in 45% Stops and 50% SMs The 8-OxoG lesion was detected in 85% of the primer extensions. The 8-OxoG lesion acted as a blocking lesion in 23% of all primer extensions (15% SMs and 8% Stops) and originated LBM in 62% of primer extensions. Bypass of 8-OxoG by Vent exo− without misincorporation occurred occasionally (15%). The 8-oxo-dA lesion blocked Vent exo−100% of the time, resulting in 90% Stops and 10% SMs. The thymine glycol lesion stopped Vent exo−67% of the time leading exclusively to Stops. These data demonstrate that both the stop position of the extended product and the position of the nucleotide misincorporation pinpoint the location of the damaged nucleotides. Therefore, the length of the extended product and the rate of misincorporations should provide two independent measures of damage frequency.

The sensitivity of the PADDA was 100% for the abasic site, 85% for the 8-OxoG lesion, 100% for the 8-oxodA lesion, and 67% for the thymine glycol lesion. This high sensitivity to detect lesions that are relatively frequent and well established biomarkers of oxidative stress (86) suggested that PADDA could be used for the mapping and quantification of endogenous DNA damage.

### Example 2

### PADDA Detects Engineered Lesions in Pre-Set Ratios Over a Wide Range of Dilutions

F-PADDA's sensitivity was tested in the presence of different types of damage in 1:1 and 1:10 pre-set ratios of abasic:8-oxodA lesions. When lesions were diluted to the 1:10 pre-set ratio, damage detection was linear when compared to the 1:1 ratio.

### Example 3

### PADDA Detects a Dose Response Over a Wide Range of H₂O₂, MMS and Sodium Bisulfite Concentrations (FIGS. 3-6)

Quantifying Strand-Specific DNA Damage by Real-Time PCR (q-PADDA)

To determine the sensitivity and dynamic range of q-PADDA to different spectra of DNA lesions, we quantified induced DNA damage after in vitro exposure to H₂O₂ and MMS. DNA damage was quantified independently for each CAN1 strand in a targeted area of approximately 600 bp. To ensure an unbiased comparison, we documented that amplification efficiencies are similar for all PCR fragments (Table 5). We also demonstrated that there is a linear relationship between the Cₚ value and the logarithmic dilution values of total DNA (R² ranging from 0.989 to 0.999; FIG. 3A). These values enable consistent and precise determination of DNA damage with all tested DNA template quantities and support the accuracy and reliability of the following DNA damage data.

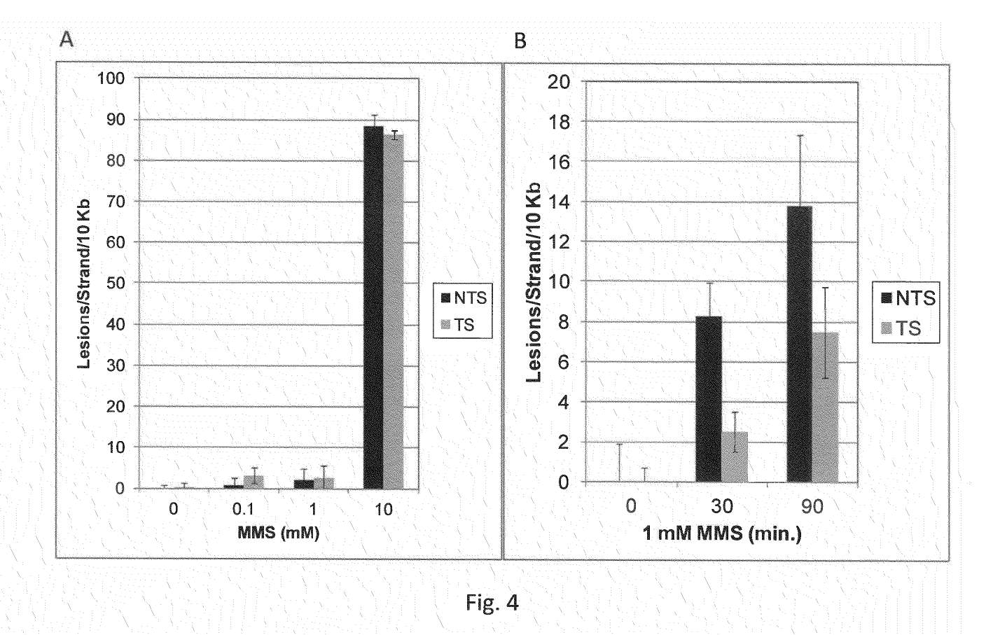

Hydrogen peroxide is an oxidative damaging agent that reproduces in vitro the most frequent types of endogenous damage present in vivo (75). Compared to the control, q-PADDA detected a significant increase in total CAN1 DNA damage for each H₂O₂ dose escalation, from the lowest dose tested (1 μM) to the highest (500 mM) (FIG. 3B). When analyzed by DNA strand, q-PADDA detected a significant (p<0.005) increase in damage in the NTS and TS for as little as 1 μM and 10 μM H₂O₂, respectively (FIG. 3B). PADDA's ability to identify a broad spectrum of DNA lesions is of major importance for the study of human populations. Therefore, we next determined PADDA's sensitivity to detect alkylated damage and the deamination of unmethylated cytosines to uracil, the most common promutagenic change in DNA. We show that PADDA has high sensitivity for both types of lesions (FIGS. 4-6).

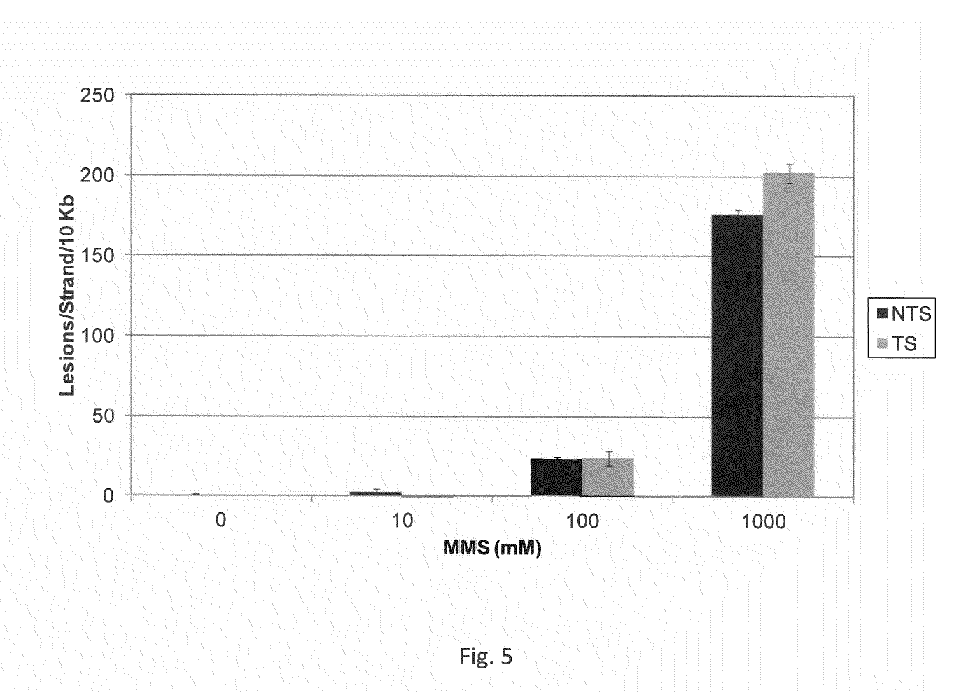

PADDA detects an increase in in vivo DNA damage induced by a dose escalation (FIG. 4A) or by just an increase in exposure time (FIG. 4B) to MMS. PADDA also detects an increase in in vitro DNA damage induced by an MMS a dose escalation (FIG. 5). However PADDA is more sensitive to detect in vivo than in vitro MMS-induced DNA damage (FIGS. 4-5). These results are consistent with the following current knowledge. MMS treatment causes mainly 3-methyl-adenine (3meA) and 7-methyl-guanine (7meG) (87). 3meA, but not 7meG, blocks polymerases leading to a stop one nucleotide before the lesion (25). 7meG is ˜11 times more frequent than 3meA (88), so most of the MMS-induced DNA damage is not detectable by polymerase based assays unless the lesions are enzymatically removed. In vivo, methylated bases are recognized and cleaved by DNA glycosylases, originating abasic sites (89) which block Vent exo−. These observations explain our results.

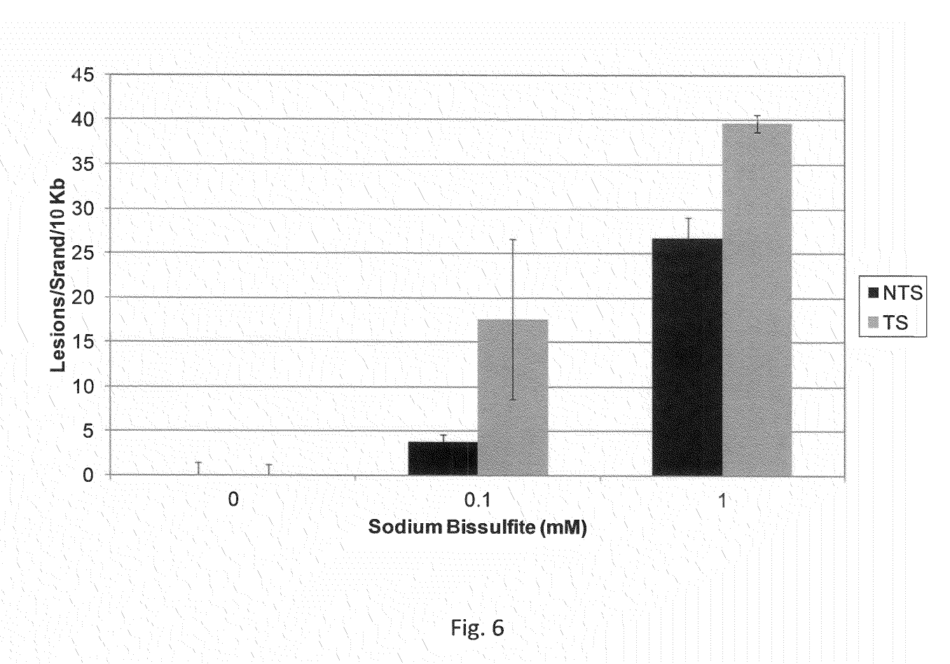

PADDA detects deamination of unmethylated cytosines to uracil as induced by exposure of naked DNA to serial dilutions of by sodium bisulfite (FIG. 6). This is consistent with the previous report that uracil completely blocks Vent exo− (90). This is an extremely important property, as deamination of cytosines to uracil is one of the most promutagenic DNA changes in vivo are recognized and cleaved by DNA glycosylases, originating abasic sites (89) which block Vent exo−.

### Example 4

### PADDA Detects a Wide Range of Levels of Endogenous DNA Damage

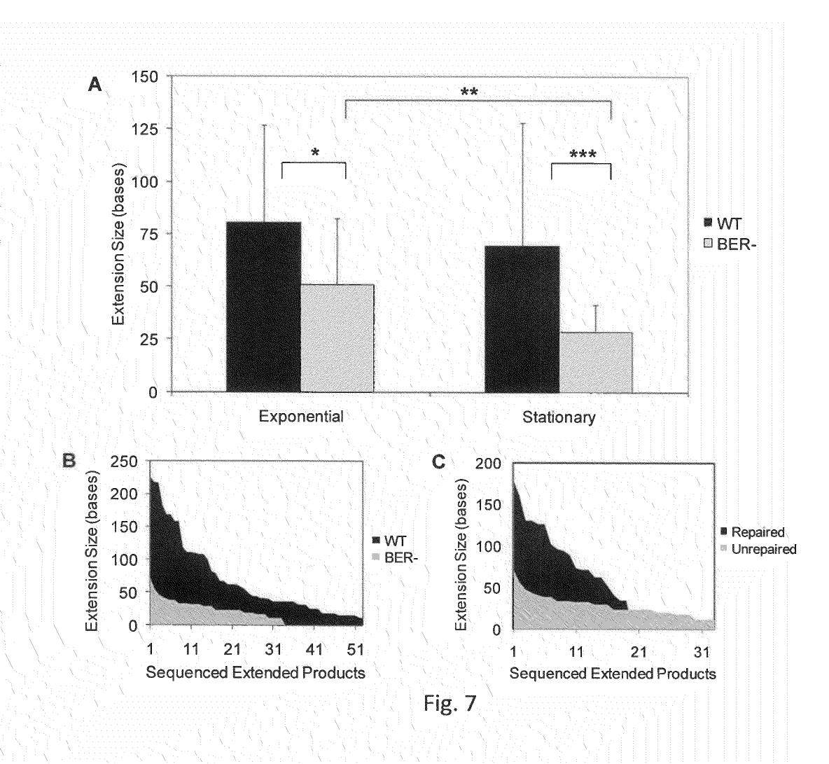

To validate f-PADDA for the detection of in vivo endogenous DNA damage, we characterized the frequency and distribution of DNA damage in the non-transcribed strand (NTS) of the actively transcribed CAN1 gene (17,30) in isogenic repair-proficient (VVT) and repair-deficient (BER⁻) S. cerevisiae strains. The CAN1 locus was chosen for DNA damage mapping and quantification, because this same region has been used to quantify specific types of oxidative DNA damage and to obtain spontaneous mutation frequencies in these strains (11). Consistent with BER⁻ cells being defective in the repair of endogenous DNA damage, DNA extracted from BER⁻ cells yielded significantly shorter extended products than DNA extracted from WT cells (FIG. 7A-B and Table 3) for both exponential (p=0.005) and stationary (p<0.000001) phases of growth. Additionally, consistent with the reported higher levels of oxidative DNA damage in stationary phase, we observed that BER⁻ cells in stationary phase yielded significantly shorter extended products (p=0.008) than BER⁻ cells in exponential phase (FIG. 7A).

To confirm that we were indeed detecting DNA damage, we performed in vitro damage repair of the genomic DNA samples before subjecting them to f-PADDA analysis. The in vitro repair assay used has been reported to repair several types of DNA damage including abasic sites, deaminated cytosines, 8-oxo-guanines and DNA nicks, however, it does not repair fragmented DNA. Remarkably, after in vitro damage repair, the length of primer extensions obtained from BER⁻ cells in stationary phase increased significantly (p<0.000001) attaining values similar to those observed for WT cells in exponential phase (FIG. 7C and Table 3). Furthermore, in vitro repair also increased significantly the length of the primer extensions obtained from WT (p=0.046) and BER⁻ (p=0.002) cells in exponential phase of growth (Table 3). These results demonstrate that PADDA detects in vivo endogenous DNA damage and that the length of the primer extensions correlates inversely with the frequency of DNA damage.

TABLE 3
Length of extended products among WT and BER− genotypes.

| | | WT | | BER⁻ | |
|---|---|---|---|---|---|
| | | In vivo | In vitro repaired | In vivo | In vitro repaired |
| Exponential | Mean ± SD | 81 ± 47 | 110 ± 51* | 51 ± 32 | 92 ± 67* |
| | Median | 76 (20-165) | 120 (20-220) | 40 (10-119) | 58 (20-245) |
| | (Range) | | | | |
| Stationary | Mean ± SD | 69 ± 59 | 69 ± 32* | 28 ± 13 | 91 ± 42 |
| | Median | 44 (11-226) | 70 (20-145) | 23 (11-72) | 89 34-180) |
| | (Range) | | | | |

All but those sizes indicated by * were determined by sequencing.
*Sizes were determined by estimating the insert-size on a 4% agarose gel having as reference previously sequenced clones, together with a 25 bp DNA ladder and 1 Kb plus DNA ladder (Invitrogen). The accuracy of the estimation was confirmed by sequencing all extended products obtained from in vitro repaired stationary phase BER− cells after running them on an agarose gel. The average size for this set of samples was determined to be within 5 bp of the average calculated after gel estimation.

### Example 5

### PADDA Detects Endogenous By-Passable DNA Damage of Highly Mutagenic Potential That Increases Significantly from Exponential to Stationary Phase

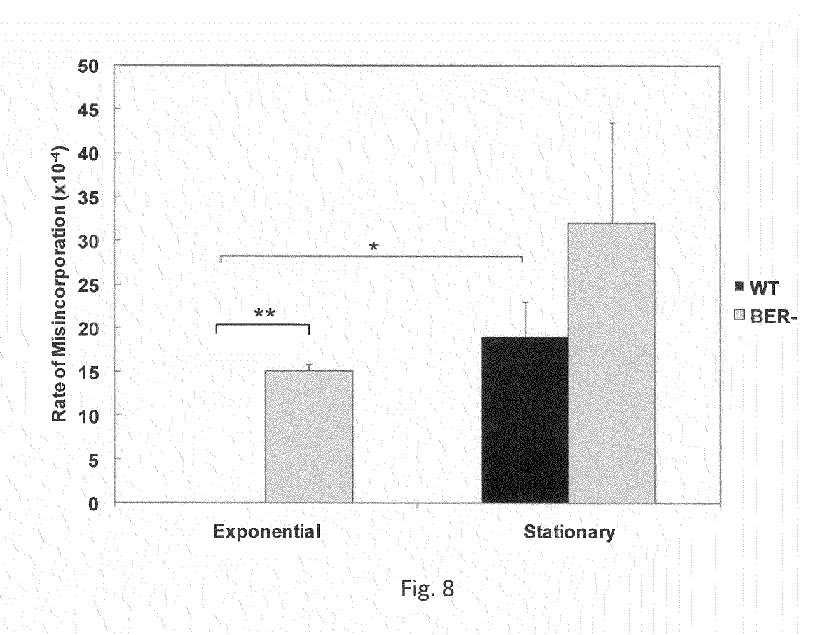

The application of f-PADDA to DNA extracted from cells in stationary phase led to a high rate of lesion-dependent misincorporations (LBMs and SMs), 19.4×10⁻⁴ in WT and 32×10⁻⁴ in BER⁻, respectively (FIG. 8). In contrast, not a single misincorporation (LBM or SM) was observed when f-PADDA was applied to DNA extracted from WT cells in exponential phase (FIG. 8). We also observed that, during exponential phase, DNA extracted from BER⁻ cells yielded significantly more lesion-dependent misincorporations (p<0.000001) than DNA extracted from WT cells in exponential phase (FIG. 8). Additionally, we observed a significant (p<0.000001) increase in lesion-dependent misincorporations in WT cells from exponential to stationary phase (FIG. 8).

The use of logistic regression to model the rate of misincorporation per base (Table 4) showed that even conservative estimates of misincorporation rates for WT and BER⁻ at stationary phase (defined by the lower bounds of 95% Cl on the estimated rate) were significantly higher (p=0.0002 and p<0.000001, respectively) than the published misincorporation rate (27) for Vent exo− (1.9×10⁻⁴). These data, together with the high rate of LBMs and SMs observed for engineered oxidative DNA lesions, demonstrate that LBMs and SMs represent lesion-dependent misincorporations opposite to a damaged base and therefore indicate directly the position of in vivo endogenous DNA damage. Together with the observed high sensitivity of the assay (FIG. 2), the capacity to detect by-passable DNA damage, such as the highly mutagenic 8-OxoG lesion (3), which are undetectable by other polymerase-based assays, indicate that f-PADDA can be used as an important tool to assess individual susceptibility to carcinogens and cancer risk.

TABLE 4
Estimated rate of misincorporation per base (SMs and LBMs) modeled by
logistic regression.

| | | Lower | | Upper |
|---|---|---|---|---|
| | | Confidence | | Confidence |
| Growth Phase | Genotype | Limit | Estimate* | Limit |
| Exponential | BER⁻ | 0.00038 | 0.00152 | 0.00607 |
| | WT | 0.00000 | 0.00000 | 0.00000 |
| Stationary | BER⁻ | 0.00104 | 0.00324 | 0.01006 |
| | WT | 0.00091 | 0.00191 | 0.00401 |

*95% confidence interval on rate.

### Example 6

### Persistent Endogenous DNA Damage Co-Localizes with Spontaneous Mutations

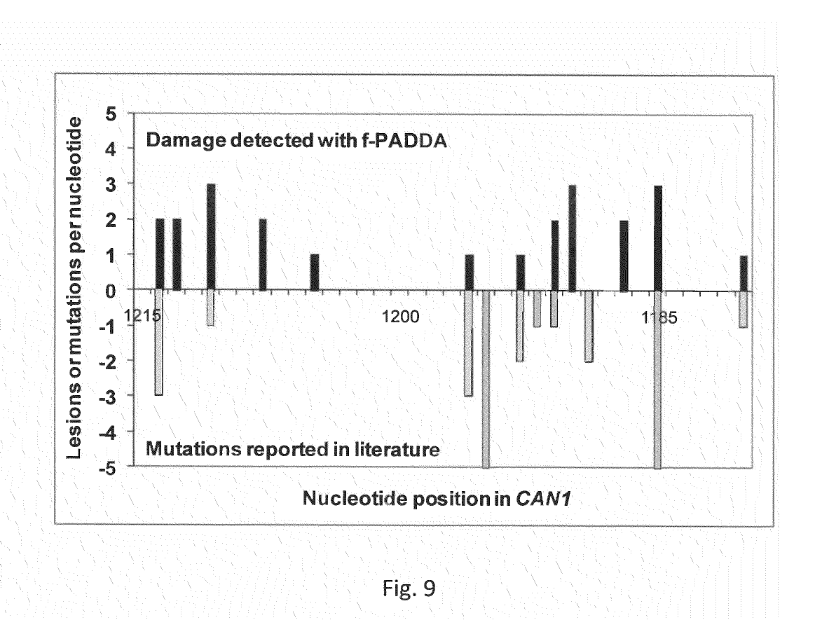

To further determine the biological significance of the results, we compared the position of the identified nucleotide damage with the published CAN1 mutation distribution (FIG. 9). Based on the results obtained with damaged synthetic oligonucleotides (FIG. 2), putatively damaged nucleotides on the genomic template were identified and mapped as follows: (a) nucleotides whose replication resulted in polymerase misincorporations, independently of whether the polymerase was stopped (SM) or able to bypass (LBM) the lesion; and (b) nucleotides that blocked the polymerase progression without resulting in polymerase misincorporation (Stop). In the last case, the location of damage was assigned to the nucleotide on the template strand immediately adjacent and 5′ to the last replicated nucleotide (FIG. 2). First, we performed a Chi-square goodness of fit test, which indicated that damage detection is not a purely random process (p<0.000001). Then, we investigated the potential association between nucleotide damage detection and mutation using Fisher's Exact Test. We determined that f-PADDA is approximately five times more likely (Odds ratio=5.1; exact 95% CI: 0.72-41.89; p=0.1 05) to detect damage on nucleotides previously reported to be mutated than to detect damage on nucleotides not identified as mutated by the literature (FIG. 9). The five-fold magnitude of the Odds ratio is quite impressive because only lesions in the non-transcribed strand of the CAN1 gene were mapped and only those mutations that disrupt the CAN1 function have been reported in the literature and considered in this analysis. These data strongly support the widely spread hypothesis that persistent endogenous DNA damage leads to mutation fixation.

### Example 7

### Endogenous Damage is Preferentially Repaired on the Transcribed Strand

PADDA, the novel assay method described herein, originates a pool of strand-specific biotin-tagged extended products, obtained from a non-cycled primer-extension reaction, which reflect with high sensitivity the levels of strand-specific endogenous DNA damage. Accordingly, the use of this pool of extended products as templates for real-time PCR reactions (q-PADDA) allows for the quantification of strand-specific endogenous DNA damage and enables us to clarify whether the preferential repair of oxidative damage occurs in vivo. To reliably quantify strand-specific DNA damage using a real-time PCR setting, we amplified two DNA fragments of different lengths: the biggest fragment is used to quantify the number of lesions, while the shortest fragment assumed to represent undamaged DNA serves as an internal normalization control. This principle is standard in real-time PCR analysis of gene expression (26,31) and has been previously demonstrated to accurately and reliably quantify DNA damage in synthetic oligonucleotides (32). However, it has not been routinely applied for quantification of DNA damage. To determine the levels of endogenous strand-specific DNA damage, we used q-PADDA to analyze the transcribed and non-transcribed strands of an actively transcribed gene (CAN1) in WT cells in exponential and stationary growth phases. DNA damage was quantified independently for each CAN1 strand in a targeted area of approximately 600 bp. To ensure an unbiased comparison, we documented that amplification efficiencies are similar for all PCR fragments (Table 5). We also demonstrated that there is a linear relationship between the Cₚ value and the logarithmic dilution values of total DNA (R² ranging from 0.989 to 0.999; FIG. 3A). These values enable consistent and precise determination of DNA damage with all tested DNA template quantities and support the accuracy and reliability of the following DNA damage data.

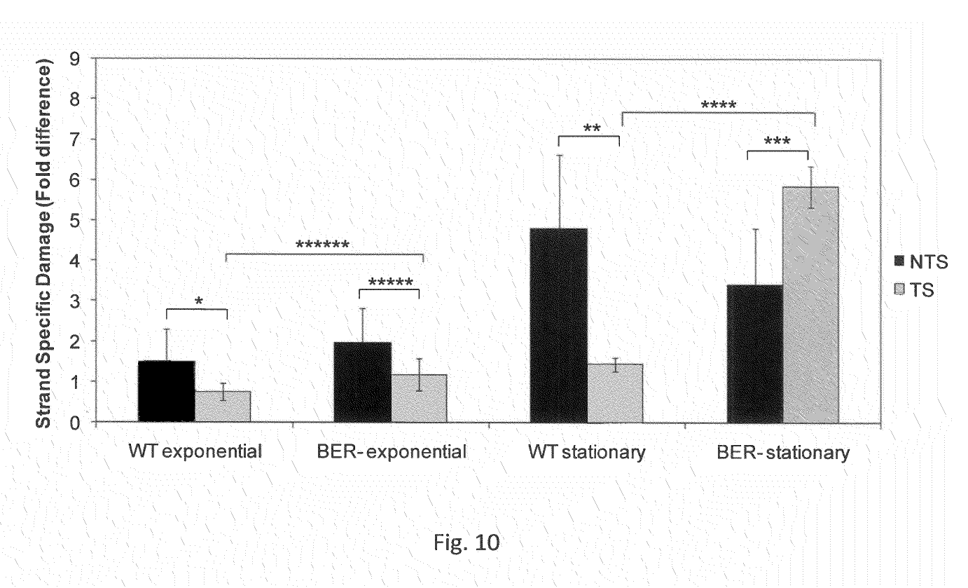

Consistent with the data obtained by f-PADDA for the CAN1 gene and the reported higher levels of ROS in yeast cells in stationary phase than in exponential phase (11, 33-35) independently of the genotype, we observed significantly more endogenous DNA damage in cells from stationary phase than from exponential phase (FIG. 10). These data demonstrate that q-PADDA allows for highly sensitive strand-specific quantification of endogenous DNA damage. To determine the relative levels of DNA damage between the transcribed and the non-transcribed strand, we first repaired in vitro the DNA obtained from WT cells in exponential phase, and then, we calculated the fold difference in damage per specific-strand relative to repaired WT. Our data shows that, independently of the growth phase, WT cells have significantly more endogenous DNA damage (p<0.001) in the CAN1 non-transcribed strand than the CAN1 transcribed strand (FIG. 10). Furthermore, the data show that in WT cells the rate of damage accumulation from exponential to stationary phase is significantly higher in the non-transcribed strand (3.2 fold) than in the transcribed strand (1.9 fold). Overall, our data indicate that in WT cells there is preferential repair of endogenous DNA damage on the transcribed strand of actively transcribed genes.

TABLE 5
Oligonucleotide parameters used in q-PADDA

| | Size of | | |
|---|---|---|---|
| Oligonucleotides | EP amplified (bp) | Strand | PCR Efficiency % |
| Sc-CAN1-1251-1224 | 68 | NTS | 96.2 |
| Sc-CAN1-1185-1214 | | | |
| Sc-CAN1-1251-1224 | 513 | NTS | 95.0 |
| Sc-CAN1-740/780 | | | |
| Sc-CAN1-1117/1151 | 68 | TS | 96.9 |
| Sc-CAN1-1209/1173 | | | |
| Sc-CAN1-1117/1151 | 628 | TS | 96.1 |
| Sc-CAN1-1769/1737 | | | |

### Example 8

### BER Repairs Preferentially Endogenous DNA Damage in the Transcribed Strand

Consistent with the known role of BER in the repair of endogenous DNA damage, we observed that, independent of growth phase, BER⁻ cells have significantly higher levels of endogenous DNA damage than WT cells (FIG. 10). Furthermore, by determining the relative levels of DNA damage between the transcribed and the non-transcribed strand relative to exponential WT in vitro repaired DNA (FIG. 10), we demonstrate that BER⁻ cells in exponential phase have significantly more DNA damage in the non-transcribed strand than in the transcribed strand (p<0.01). However, and in contrast with WT cells, BER defective cells in stationary phase have significantly more endogenous DNA damage (p=0.002) in the CAN1 transcribed strand than in the CAN1 non-transcribed strand (FIG. 10). These data demonstrate that in BER⁻ cells, the rate of damage accumulation is significantly higher (p=1×10⁻⁴) for the CAN1 actively transcribed strand (5 fold) than for the non-transcribed strand (1.7 fold), establishing for the first time that BER plays a major role in the preferential repair of endogenous DNA damage localized in the transcribed strand of actively transcribed genes.

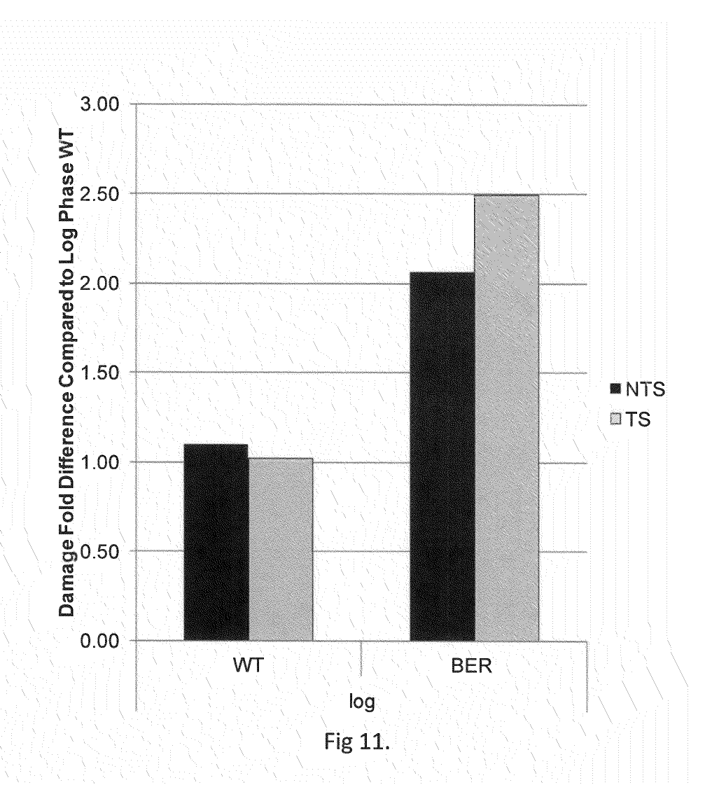

Using the probe method with q-PADDA on an IQ5 machine, data similar to that obtained with the q-PADDA SYBR Green method was obtained (FIG. 11).

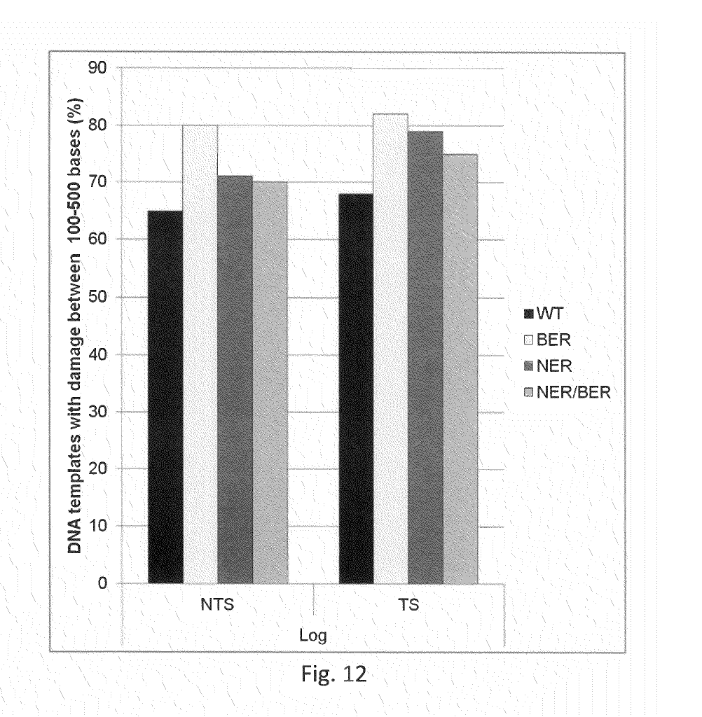

We demonstrated with digital droplet PCR an increase in amount of damage in DNA repair defective yeast (FIG. 12). Furthermore, and consistent with previous data, we showed strand specific differences in DNA damage between WT and BER− repair defective yeast in each stage of growth

### Example 9

### PADDA Detects In Vivo UV-Induced DNA Damage

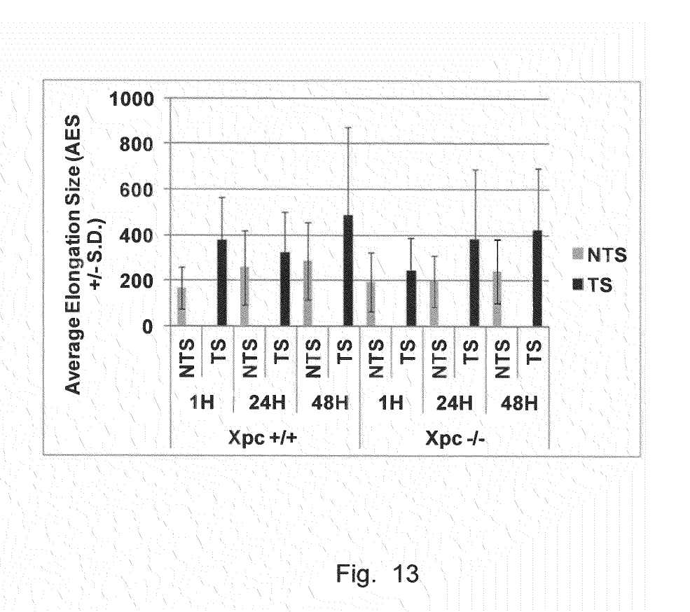

To demonstrate the applicability of PADDA for detection of DNA damage in mice, we detected in vivo DNA damage induced through UVB irradiation in mice heterozygous for p53 and homozygous mutant (XPC−/−) or WT for the Xpc protein. Xeroderma pigmentosum is an extensively studied disease associated with defects in nucleotide excision repair or defects in translesion DNA synthesis, in which patients are highly prone to UV-induced cancers (65). A defect in one of the genes associated with this disease, xeroderma pigmentosum complementation group C, or Xpc, is responsible for removing a variety of lesions including bulky adducts and UVB-induced modifications in di-pyrimidine sites in DNA such as cyclobutane pyrimidine dimers (CPD) and 6-4 photoproducts in inactive bulk DNA and the non-transcribed strand of transcriptionally active genes (65-68). Therefore, UVB irradiation in cells deficient in the Xpc protein would be expected to contain more UVB-induced damage that persists unrepaired in the NTS compared to wild-type mice with proficient DNA repair. To determine if PADDA could detect in vivo UVB induced DNA damage, we irradiated WT and Xpc−/− mice with UVB and extracted DNA at 1, 24, and 48 hours after irradiation and detected DNA damage using f-PADDA in the p53 gene of each strand, mice, and time point. In the WT mice, at 1 h in the TS, the average elongation size (AES) was 375 bases, and increased to 500 bases after 48 h (FIG. 13). In the NTS, at 1 h, the AES was 166 and increased to 300 bases after 48 h. For Xpc−/− mice, in the TS at 1 h, AES was 250 bases and increased to 450 bases after 48 h (FIG. 13). However, in the NTS, at 1H, AES was 150 bases but increased only to 240 bases after 48 h (FIG. 13). Additionally, AES for the NTS of Xpc−/− did not begin increasing until after 24 h (FIG. 13). This data shows that PADDA detects strand and nucleotide specific in vivo UVB-induced DNA damage and demonstrates that this damage persists only in the NTS of Xpc−/− mice. In summary, within genotypes, and consistent with established knowledge, more damage was detected in the NTS vs. the TS. Additionally, higher levels of DNA damage were detected in Xpc−/− mice irradiated with UVB than in WT irradiated and in non-irradiated controls, demonstrating this assay detects UVB-induced damage as well.

### Example 10

### PADDA Detects In Vivo Induced DNA Damage at a Codon Previously Reported to be Mutated in Tumors, Documenting In Vivo Lesion-Mutation Co-Localization

Previously, we mapped the spectrum of mutations in tumors arising in the p53 gene in Xpc defective mice exposed to UVB, and found interestingly that a non-dipyrimidine site produced 64% of the tumors analyzed in Xpc deficient mice after UVB irradiation (69), suggesting a novel DNA lesion produced at this site by UVB and repaired by Xpc. More specifically, 41% tumors of tumors examined had a tandem mutation in codon 122 in this non-dipyrimidine site, producing AC→TT or AC→CT mutations at A259 and C260 nucleotides. Additionally, 23% of the tumors originated from a single mutation at the methylated C260 nucleotide in codon 122, which is not part of a dipyrimidine site. To investigate the origin of this nucleotide lesion that acts as a precursor of neoplastic mutations, we used a PADDA to investigate the origin of tumor mutations that we reported previously on codon 122 of the p53 tumor suppressor gene (Trp53) in UVB-radiation induced mouse skin tumors. A significant increase in lesions is detectable on the NTS of Trp53 codon 122 in Xpc^{-/-} Trp53^{+/-} mice 24 h after exposure to UVB-radiation.

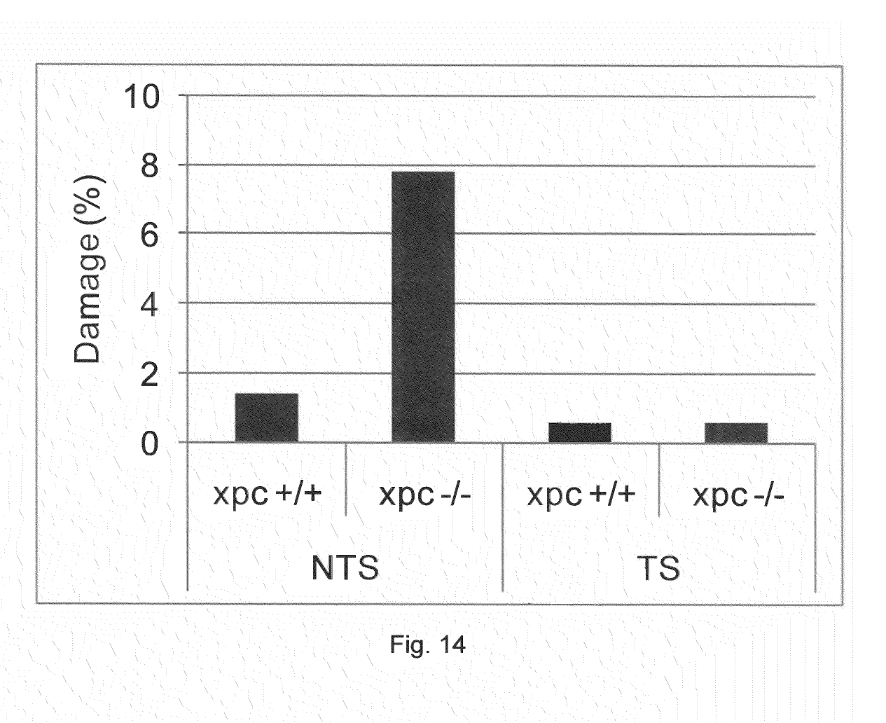

Our methodology demonstrates a significant increase (p=0.0109, Fisher's Exact Test) of putative lesions on the NTS of codon 122 in skin genomic DNA from Xpc^{-/-} Trp53^{-/-} mice 24 h after a single exposure to UVB-radiation (FIG. 14); 11 out of 144 clones analyzed (7.6%) reflect putative damage at C260, A259 or both.

These findings contrast with the low level of damage observed: (i) in irradiated Xpc^{+/+} Trp53^{+/-} animals in which only 2 of 145 clones (1.4%) manifest possible base damage on the NTS of codon 122 (FIG. 14) and in which there is an absence of complex stops with misincorporation (CSM) (see below); (it) on the TS of codon 122 in which only 1 of 143 clones per genotype (0.7%) reflect such damage (FIG. 14) These findings suggest that a significant fraction of the damage on the NTS of codon 122 remains unrepaired 24 h after UVB-radiation exposure in Xpc^{-/-} Trp53^{+/-} mice. In addition, only in this group of animals and exclusively on the NTS of codon 122 all categories of putative lesions (Stop, LBM, SM, CSM) are detected (FIG. 14).

Each category of putative lesions (Stop, LBM, SM, CSM) is strictly localized on the NTS of Trp53 codon 122 and the lesions co-localize with the tumor mutations. Each category of putative lesions (Stop, LBM, SM, CSM) detected on the NTS of codon 122 in Xpc^{-/-} p53^{+/-} mice 24 h after exposure to UVB-radiation is strictly associated to a specific nucleotide. Specifically, all Stops and LBM's are at C260, while the SM is at A259. These are precisely the same bases of codon 122 that we previously reported mutated in UVB-radiation induced tumors from the same genotype, thus indicating a lesion-mutation co-localization. Xpc^{-/-} Trp53^{+/-} mice sacrificed 48 h after a single exposure to UVB-radiation have increased levels of putative lesions at the NTS of Trp53 codon 122.

In a previous report we were unable to detect genomic mutations at codon 122 earlier than 2 weeks after UVB-radiation exposure (91), leading us to hypothesize that UVB radiation-induced damage at codon 122 persists for approximately 2 weeks. This finding is consistent with a report (92) that identified photoproducts in the skin of human volunteers 3 weeks after exposure to UV radiation. To further validate our novel assay, we did a preliminary quantification of putative lesions in the skin genomic DNA from Xpc^{+/+} Trp53^{+/-} and Xpc^{-/-} Trp53^{+/-} mice sacrificed 48 h after a single exposure to UVB radiation. We analyzed 50 clones per genotype. Consistent with the results obtained 24 h after UVB radiation exposure, two Stops (at C260), a LBM (C→T at C260), and a SM (A→T at A259) on the NTS of codon 122 were found in a Xpc^{-/-} Trp53^{+/-} mouse sacrificed 48 h after UVB-radiation exposure. In contrast, only one Stop was found on the NTS (at G261) and on the TS (at T259) in the irradiated Xpc^{+/+} Trp53^{+/-} controls. This result suggests that 48 h after UVB radiation exposure Xpc^{-/-} Trp53^{+/-} animals still have significant levels of damage on the NTS of codon 122 and is consistent with the model that the tumor mutations we previously reported at this site may arise from persistence of unrepaired lesions which require XPC for repair.

Tandem mutations in Xpc^{-/-} Trp53^{+/-} mice exposed to UVB radiation previously reported most probably arise from translesion synthesis opposite a novel DNA lesion induced by UVB and repaired by Xpc. However, and interestingly, when we screened mice genomic DNA using PADDA with the addition of Dpo4, we observed a new category of lesion we termed complex stop with misincorporation (CSM), in which the arrested polymerase misincorporated two bases opposite a lesion(s). Additionally, when in vivo translesion synthesis was replicated in vitro, we observed CSM's only in the NTS of Xpc^{-/-} Trp53^{+/-} irradiated mice 24 h after exposure to UVB. Interestingly, one of these CSM's was a CA→TT, the same “fingerprint” seen in codon 122 tumors possessing CA→TT mutations

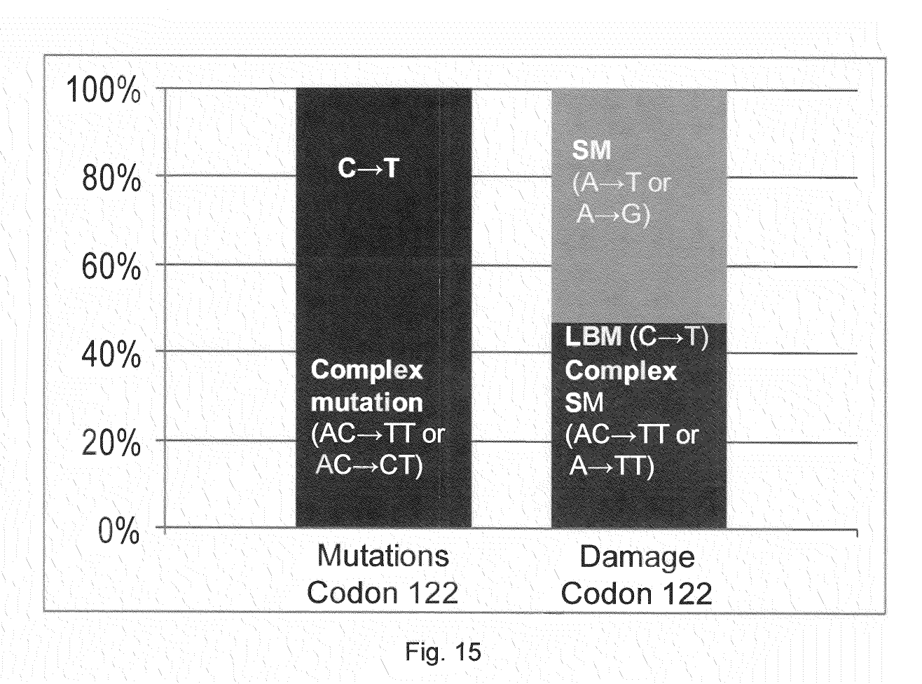

Collectively, the results illustrated in FIGS. 14 and 15 are consistent with the notion that the tumor mutations that we previously reported at codon 122 arise from base damage strictly localized on the NTS of this codon, manisfest through translesion synthesis by a y-family polymerase, and support the requirement of XPC for the repair of the NTS of transcriptionally active regions (66-68, 93-96). Most putative damage at codon 122 was represented by misincorporations, providing a reasonable explanation for our previous observation that most tumor mutations affect C260 and A259 (AC→TT and AC→CT mutations; FIG. 15). Stop with Misincorporation (SM), suggesting lesion-dependent replicative arrest with nucleotide misincorporation opposite the damaged A259. This suggests damage at A259 or at both C260 and A259. This observation is also consistent with reported in vitro studies (97) showing that in oligonucleotides containing some types of UV radiation-induced dinucleotide photoproducts, Vent exo⁻ can advance the primer to opposite two adjacent damaged bases, thus arresting at the second damaged base encountered. Lesion Bypass with Misincorporation (LBM), which is consistent with lesion-dependent misincorporation opposite a damaged C260, providing a reasonable explanation for the origin of the C→T tumor mutations at C260. Complex Stop with Misincorporation (CSM), which was seen only in experiments using Vent exo(−) in tandem with Dpo4, which may represent in-vivo translesion synthesis opposite sites of damage. These data provide a reasonable explanation for the origin of the complex AC→TT and AC→CT mutations. Additionally, these data suggest the complex mutations (AC→TT and AC→CT) mutations observed only in UVB irradiated Xpc−/−, trp p53+/− mice arise from damage tandemly affecting A259/C260 that is bypassed in a mutagenic fashion by a y-family polymerase.

The diversity of categories of putative lesions (Stop, SM, LBM, and CSM) was exclusively observed on the NTS of codon 122 in Xpc^{-/-} Trp53^{+/-} mice exposed to UVB-radiation (FIG. 15). This may suggest that chemically distinct lesions (and/or different isomers of one or two specific lesions) lead to the different tumor mutations (AC→TT, AC→CT and C→T) that we reported previously at codon 122. This was a possibility that we anticipated in a previous report (69). As we discussed earlier, each Stop, SM, and CSM could represent simultaneous damage at A259 and C260. Conceivably, by affecting two adjacent bases, these lesions may cause dramatic structural changes, thus leading to arresting lesions (Stop, SM, and CSM) that lead to the tandem double tumor mutations (AC→TT, AC→CT). Additionally, the SM could lead to the infrequent AC→CT (14%) tumor mutations. Furthermore, the single-base substitution C→T mutation at C260 (36% of the tumor mutations; could arise from by-passable lesions (LBM) affecting only C260. Indeed, damage at C260 only appears to be an error-prone by-passable lesion both in vivo (tumor data) and in vitro (our novel assay). In fact, when in vivo translesion synthesis was mimicked by the addition of a y-family polymerase, we observed CSM's only in the mutant genotype, including the AC→TT CSM similar to the AC→TT tumor mutation. It is well established that stalled DNA replication in vivo at sites of DNA damage by a processive polymerase can lead to several outcomes; (i) recruitment of DNA repair proteins, repair of the lesion, and subsequent re-initiation of extension along the template; (ii) abolishment of replication and cellular death; (iii) recruitment of y-family polymerase capable of bypassing the lesion in a potentially mutable mechanism. Therefore, re-creation of translesion synthesis to mimic in vivo situations has the potential to generate important data regarding the mutability of DNA lesions at certain sites within a genome. Furthermore, the absence of damage, detectable with the native form of Vent, in mice Xpc−/−, p53+/− 24 h after UVB suggests that mutations at lesions in codon 122 arise due to interaction of damaged bases with a polymerase without exonuclease activity. Our assay demonstrates for the first time that the lesions that give rise to the reported tumor mutations in codon 122 arise from strand-(NTS), genotype-(Xpc^{-/-} Trp53^{+/-}), UVB-radiation- and site-dependent unrepaired lesions affecting C260 or both C260 and A259. Our results also suggest that the tandem mutations previously reported in T122 in UVB induced tumors arise through a trans-lesion synthesis mechanism in conjunction with a y-family polymerase. These lesions are detectable with our assay as early as 24 h after a single exposure to UVB-radiation, thus months or years before tumors can be detected.

Here we provide evidence that the Trp53 codon 122 tumor mutations that we previously reported may arise from the persistence of un-repaired UVB-radiation induced damage—which specifically requires XPC for its repair—located at C260 and A259 of the NTS of codon 122, and result from interaction of a y-family polymerase with damaged bases.

### Example 11

### PADDA Detects Endogenous DNA Damage in Mice

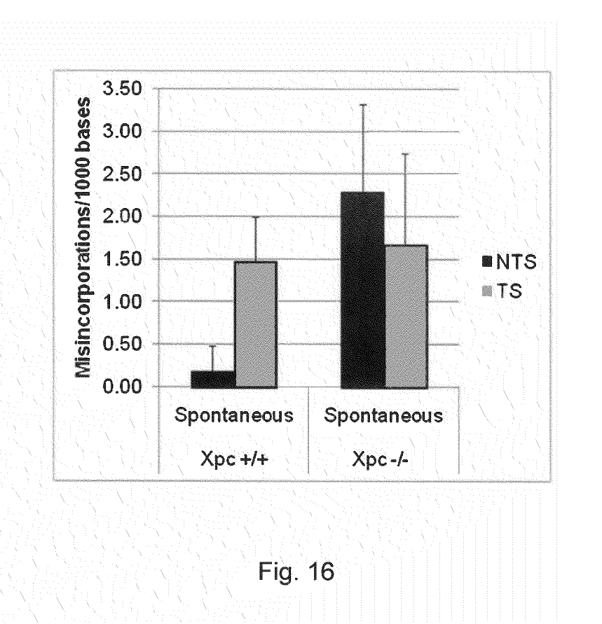

To demonstrate the applicability of PADDA for the detection of spontaneous DNA damage in mice, we extracted skin DNA without exposure to specific genotoxics and detected DNA damage using f-PADDA in the p53 gene of WT and Xpc−/−, p53 heterozygous mice. When misincorporation (consisting of SM's and LBM's) frequency of Vent (−) was calculated, for the NTS of WT, the misincorporations/1000 bases was 0.2, compared to 2.2 for Xpc−/− (FIG. 16). For the TS, misincorporation frequency for both the WT and Xpc−/− was approximately 1.5 (FIG. 16). The rate of LBM's/1000 bases in the NTS for VVT was 0.2 versus 1.2 in Xpc−/−. Additionally, the rate of SM's/1000 was increased in the NTS of Xpc−/−, at 1.2 compared to 0.6 in the WT. Together, this data shows that PADDA is able to detect differences in levels of endogenous DNA damage between diverse strains of mice and within strands of the same genotype. Consistent with the results found in yeast, in mice accumulating only spontaneous DNA damage (un-irradiated), levels of DNA damage were higher in mice compromised in DNA repair (Xpc−/−) when comparing to WT mice.

### Example 12

### PADDA Detects In Vivo Induced and Endogenous DNA Damage in Humans

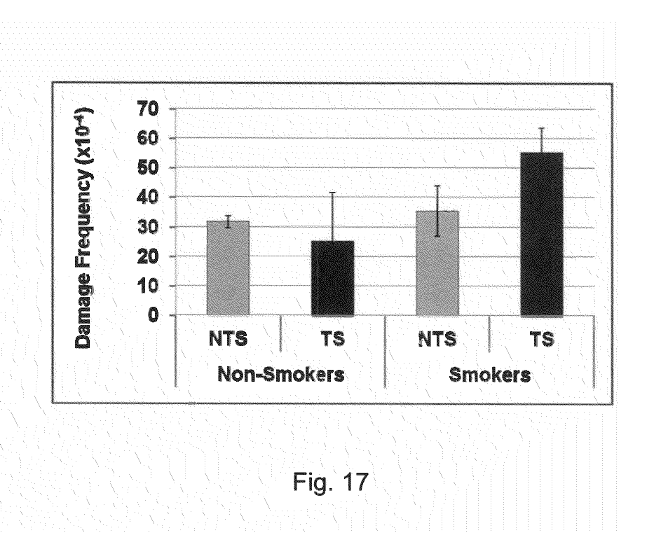

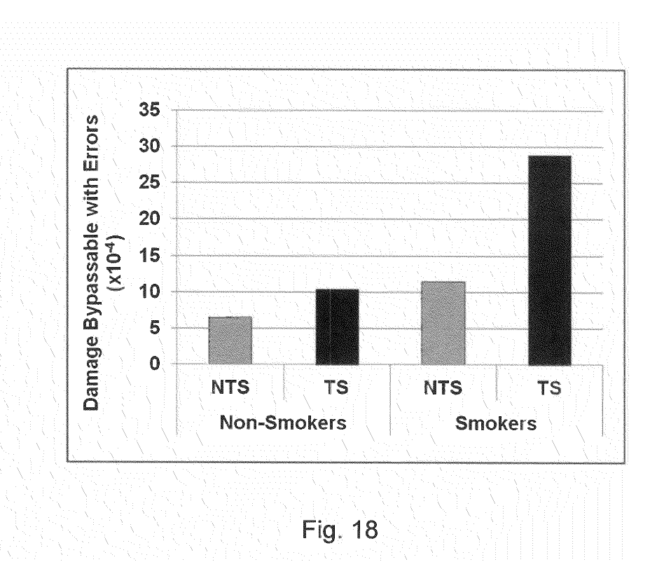

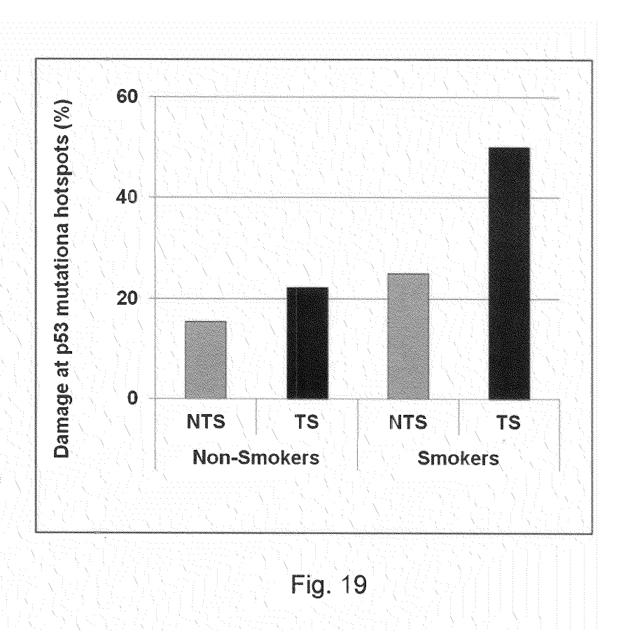

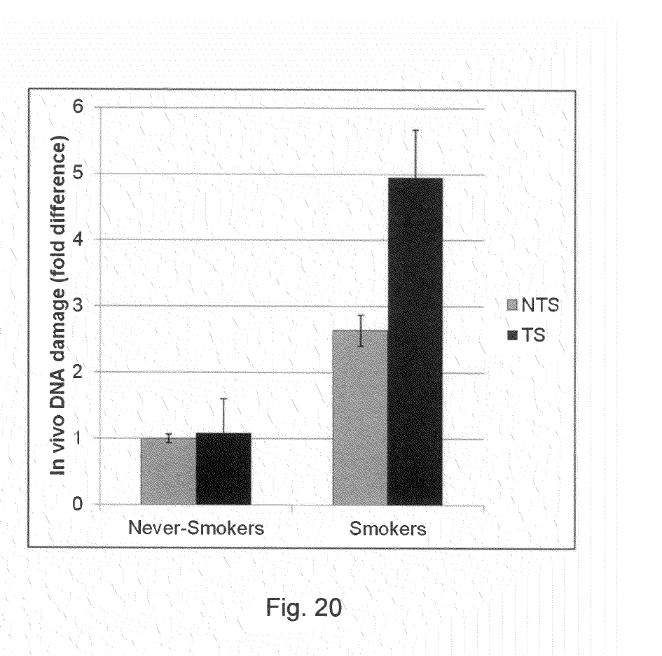

To determine whether PADDA was applicable to study in vivo DNA damage in humans, we used f-PADDA to quantify damage in the p53 gene in exons 7 and 8 of DNA extracted from non-invasive scrapings of buccal cells from healthy controls as well as smokers. Exons 5, 7, and 8 of the p53 gene are commonly mutated in oral tumors at specific hotspots (98) and therefore detecting DNA damage at these hotspots may lead to early detection of cancer or determination of cancer risk. When the damage frequency was calculated for each strand/exon/smoking status of patients, we observed the least amount of damage frequency in the TS of non-smoker individuals (FIG. 17). When comparing damage frequency in the NTS healthy patients and smokers, we again observed that least damage frequency occurred in the non-smoking individuals) (FIG. 17). Furthermore, in non-smokers the least damage frequency occurred in the TS compared to the NTS, reflecting established concepts that the TS is repaired more efficiently than the NTS. Moreover, when we calculated the average misincorporation frequency in the exons per 10,000 bases, we observed that in the TS, smokers had significantly higher rates of misincorporations than non-smokers (FIG. 18). Additionally, since certain p53 mutational hotspots are associated with smoking (98), we compared the location of detected damage to the previously reported mutations (98). Remarkably, we found that for the TS, 50% of the detected lesions in the smokers were at sites previously reported to be mutated in oral tumors (FIG. 19), whereas for non-smokers only 22% of the damage occurred at mutational hotspots (FIG. 19). Additionally, for the NTS, 25% of the damage in smokers was at previously reported mutations, compared to 15% in non-smokers (FIG. 19). Furthermore, in vivo DNA damage quantification on the p53 gene is significantly higher in the oral mucosa of smokers than in never-smokers as measured by q-PADDA (FIG. 20). As exposure and repair efficiency of tobacco induced DNA lesions is a major determinant of cancer risk, q-PADDA's ability to detect on a high throughput setting levels of tobacco induced DNA damage may facilitate screening of individuals for cancer risk after tobacco exposure. Additionally, the ability of PADDA to detect a variety of in vivo DNA lesions derived from tobacco smoke demonstrates PADDA's superior sensitivity over other assays that are unable to detect multiple in vivo smoke induced DNA lesions. These data clearly demonstrate that PADDA is capable of detecting in vivo levels of endogenous and induced damage from only minute amounts of DNA taken from patients. Additionally, and very importantly, our data demonstrate that PADDA is able to detect at the nucleotide level damage that leads to neoplasic mutations in humans.

### Example 13

### PADDA can be Used to Study Polymerase Behavior

To demonstrate the dynamic range of data generated with f-PADDA when different polymerases and ions with different ion concentrations are used, we performed primer extensions on mice and yeast genomic DNA with different polymerases and ions with different concentrations. Primer extensions on yeast and mice DNA of different genotypes were performed with Vent, Vent exo−, Dpo4 (Trevigen), Taq, and combinations of the at least three polymerases. Additionally, each of the above polymerases was tested in the primer extension with Manganese (Mn) and Magnesium (Mg) in varying concentrations. We observed dramatically different behaviors at sites of DNA damage of each polymerase depending on the ion and ion concentration used. For example, only with Vent exo (−), Dpo4 and magnesium in the primer extension did we observe a Complex SM (consisting of a double misincorporation and arrest at the site of a tandem lesion) in codon 122 in the NTS of Xpc−/− 24 h after UVB irradiation. Additionally, using manganese at 2-5 mM in the primer extension dramatically increased the rate of LBM's measured compared with 2-5 mM Mg. However, with decreasing manganese concentrations in the primer extension, damage detection decreased with each of the polymerases tested. Similar behavior with similar conditions were observed on yeast genomic DNA.

Summary of Data Obtained Via q-PADDA

The q-PADDA embodiment of the presently disclosed and claimed inventive concepts has been validated by detecting strand/gene specific DNA damage levels in yeast, mice, and human genomic DNA. F-PADDA has been validated by detecting nucleotide specific DNA damage levels and locations in yeast, mice, and human genomic DNA. To demonstrate q-PADDA's applicability for high-throughput analysis, we determined its ability to differentiate levels of endogenous DNA damage in both strands between WT and a strain deficient in Base Excision Repair (BER⁻) in exponential phase. In vitro repaired WT DNA (with PreCR repair kit, NEB) provided a control for the amount of damage in each strand. We observed that BER⁻ cells had significantly more damage than WT cells in both the non-transcribed (NTS) and the transcribed (TS) strand. We also observed that within each genotype the NTS had significantly more damage than the TS. These data are consistent with current views that the TS has a preferential repair rate and demonstrate that this new assay allows for strand-specific analysis of oxidative DNA damage with high sensitivity. Importantly, consistent with the fact that we are detecting a variety of lesions with high sensitivity, we established significant differences between WT and BER⁻ cells on a per strand basis even during exponential phase, when the levels of Reactive Oxygen Species (ROS) and DNA damage are expected to be lowest. When cells were grown to stationary phase, when higher levels of ROS are present, cells of the same genotype and strand had higher levels of DNA damage in stationary compared to exponential phase cells. In WT cells in stationary phase, the NTS accumulated more damage than the TS, reflecting established concepts that the TS is repaired preferentially compared to the NTS. However, when DNA damage was detected in BER⁻ defective cells in stationary phase, more damage was present in the TS compared to the NTS. Through the use of q-PADDA, we were able to distinguish an important and novel role of the BER⁻ pathway by showing that it is responsible for the preferential repair of the TS. This novel role of BER⁻ has been extremely controversial in the field of DNA repair as no other assay previously was able to accurately measure levels of endogenous DNA damage between strands. This highlights the importance of q-PADDA's applicability for generating novel data.

Summary of Data Obtained Via f-PADDA

This embodiment of the present novel DNA-damage detection assay of the presently disclosed and claimed inventive concepts has been used to generate extensive data in yeast, mice and humans. In one embodiment, the f-PADDA method was performed by cloning PCR products into plasmid vectors, transforming into and growing the plasmid vectors in E. coli, and amplifying the colony bacteria containing the clones in order for sequencing. Therefore, some of the data obtained for f-PADDA was generated through this procedure, which took 2 days to generate data relating to the nucleotide location of lesions. However, in another embodiment, the method of the presently disclosed and claimed inventive concepts is a high-throughput assay that allows one to obtain the same type of data in less than 7 hours (used to characterize f-PADDA performance in the presence of a mixture of types of damage, characterization of lesions in irradiated mice, and mapping of DNA damage in humans) and relies on the use of a Real-Time PCR approach to amplify single extended products (EPs). Through the use of f-PADDA, we were able to demonstrate an unprecedented high correlation of locations of endogenous DNA and endogenous mutations lesions in Yeast. Additionally, with f-PADDA we were able to establish a high correlation between locations of UVB induced DNA damage and UVB induced mutations in mice. Furthermore, and very importantly, we were able to establish a correlation in humans between locations of in-vivo smoking induced DNA damage and mutations in the p53 gene.

Discussion

Despite the profound implications of endogenous DNA damage in human diseases (1,2,3,4) and mounting evidence that oxidative damage in the transcribed strand of actively transcribed genes block transcription (19,36), due to technical limitations prior to the presently disclosed and claimed inventive concepts it had been impossible to document transcription-coupled repair of endogenous DNA damage (19), or even establish the overall levels of endogenous DNA damage in different cell systems (7,10).

The presently disclosed and claimed inventive concepts constitute novel primer-anchored DNA damage detection assays (PADDA) with sufficient sensitivity and specificity to enable the mapping and quantification at the single nucleotide level of in vivo endogenous base damage in cells such as eukaryotic cells including, but not limited to, yeast, mice and human cells. To the best of our knowledge, PADDA is the first technique that has the sensitivity to quantify and differentiate strand-specific levels of endogenous DNA damage in at least one of 1, 2, 3, 4, 5, or 6 hours or less after DNA extraction. PADDA belongs to a general class of approaches that take advantage of polymerase elongation properties as a sensor for damage on the template DNA (13-16,37,38). Particularly, PADDA can be included in a sub-class of assays that embrace TD-PCR (13,37), ss-QPCR, sslig-PCR (14), and QPCR (15). These other polymerase-based damage detection assays can map and quantify to some degree chemical and radiation induced DNA damage. However, due to multiple limitations they are neither widely used for the detection of induced DNA damage nor reliable for the detection of endogenous DNA damage. As noted above, these limitations include: (i) low sensitivity, (ii) high background, (iii) capacity to identify only DNA damage blocking lesions or technically introduced DNA strand breaks, (iv) requirement of radioactive materials and multiple step optimization for each genomic area in study, and (v) end-point quantitative PCR analysis. In contrast, PADDA, of the presently disclosed and claimed inventive concepts, is highly sensitive, simple to perform, relatively inexpensive, and does not require hazardous reagents, sophisticated equipment or specialized skills.

The high sensitivity of PADDA results from the combination of at least one of the following several factors including: (a) a DNA extraction procedure that aims to reduce damage introduced during processing; (b) a single non-cycled primer-extension step, which prevents the successive annealing of previously extended products to different template molecules, assuring that each extended product reflects nucleotide damage at a single strand and cell level, thus facilitating the detection of even very low levels of nucleotide lesions; (c) the use of a tagged, specific primer, such as a 5′-biotin-tagged specific primer, combined with several purification steps aimed at reducing spurious background; (d) the use of a polymerase (such as, but not limited to Vent exo−) with high sensitivity to detect DNA damage and high primer-extension efficiency (22-24,39); (e) the use of an adapter-primer chemically modified to decrease artifacts; (f) use of a highly efficient single-strand adapter ligase (25); (g) the ability to retrieve information about damaged sites from sequenced individual primer extensions, allowing the mapping of lesions that lead to polymerase bypass or arrest with misincorporation opposite to a damaged nucleotide, thereby extending the assay's damage detection capacity to a broader range of lesions than previously reported assays; (h) the strategy to quantify damage using real-time PCR analysis, rather than end-point analysis, allowing the detection of subtle differences in damage levels, and enabling a practical and rapid high-throughput DNA damage detection assay relevant to population screenings; and (i) the optional use of in vitro repaired DNA, which theoretically contains minimal levels of DNA damage in both strands, permitting for the first time the ability to evaluate the relative levels of damage between the two strands of a given gene.

We have used isogenic WT and BER⁻ yeast cells in distinct phases of cell growth as a model to validate our novel assay but the presently disclosed and claimed inventive concepts are not limited to the use of these cells. BER involves proteins with overlapping specificities. The BER⁻ cells used in our study have deletions of ntg1 and ntg2, N-glycosylases required for the removal of oxidized pyrimidines and other lesions, and apn1, the major apurinic-apyrimidinic endonuclease in S. cerevisiae (11). BER⁻ and WT cells have similar and very low rates of cell death ((11,40) and data not shown). Our data demonstrate that BER⁻ cells have significantly higher levels of endogenous damage than WT cells. These data are consistent with the reported significantly higher levels of O₂⁻ (34,35) and Ntgp1 recognized DNA lesions (11) in BER⁻ cells compared to the WT cells. Furthermore, consistent with the reported levels of Ntgp1 recognized DNA lesions (11) and ROS (11,33,41), we observed that for both genotypes, cells in stationary phase have significantly higher levels of damage in both DNA strands than cells in exponential growth phase. Overall, for the first time these results demonstrate that PADDA's high sensitivity provides a tool for strand-specific mapping and quantification of endogenous DNA damage.

The sensitivity of other DNA damage detection assays after in vitro H₂O₂ damaged DNA has not been reported. Nonetheless, exposure of naked DNA for 1 h to 5 mM H₂O₂ or human cells for 1 h to 50 mM H₂O₂ yields a nearly identical damage patterns (75) and an equivalent global damage frequency (76). Assuming that this 10 fold difference is maintained across H₂O₂ concentrations, q-PADDA is at least 10 to 100 fold more sensitive than the most sensitive assays currently used to quantify induced oxidative damage, such as the comet assay (77), SL-RT PCR (78), and Q-PCR (78). Plus, in contrast with these assays, PADDA does not require enzymic hydrolysis of the lesions and can discriminate damage between each DNA strand. Overall, these data demonstrate that q-PADDA has very high sensitivity to oxidative DNA damage and is able to discriminate a dose response over a wide range of H₂O₂ concentrations.

Most of the identified putative damage on the CAN1 gene is represented as Stops. We observed a significant variation in the size of extended products that is consistent with the expected relative levels of damage for each strain and growth phase studied. This is consistent with previous reports that used the Vent exo− polymerase to detect chemically distinct photoproducts (13,21,37) and the fact that multiple nucleotide lesions represent effective blocks to DNA replication (42). Consistent with the Stops representing authentic DNA lesions, we also observed a significant increase in the size of extended products after in vitro repair. The repair system used contains several enzymes that have shown to repair oxidative damaged DNA (43-45), and share significant substrate overlap with Ntg1p and Ntg2p recognized lesions (44,45).

In addition to Stops, we observed high levels of polymerase misincorporation (SMs and LBMs) in BER⁻ cells, which have been shown to accumulate high levels of ROS (33,34) and Ntg1p recognizable lesions (11, 33-35), but no SMs or LBMs in WT cells in exponential phase of growth, which are reported to have low levels of ROS and undetectable levels of Ntg1p recognizable lesions (33,34). This is consistent with LBMs and SMs representing lesion-dependent misincorporations opposite to a damaged base, and therefore being direct indicators of the position of in vivo DNA damage. The observation of misincorporation at the stop-site (SM), or polymerase bypass with a misincorporation opposite the damaged base (LBM) in non-genomic DNA is well established (46). However, f-PADDA is the first DNA damage detection methodology that documents the in vivo position of genomic damage leading to lesion-dependent misincorporations (SMs and LBMs). This capacity to expose the potential mutagenicity of the damaged DNA, usually only revealed during its replication by a DNA polymerase (47,48), is a unique and important advantage of the present novel assay method.

The observation that persistent endogenous nucleotide damage in the CAN1 gene co-localizes with CAN1 spontaneous gene mutations strongly reveals the importance of PADDA in the detection of damage with highly mutagenic potential. In this regard, the detected LBMs indicate that PADDA detects lesions that may lead to in vivo error-prone translesion DNA synthesis, and ultimately to mutation fixation in vivo. Error-prone replicative by-pass of chemically modified DNA bases (LBM in our data) is a biologically significant process in mammalian cells leading to hyper-mutability and subsequent cancer predisposition, such as in the disease xeroderma pigmentosum variant form (46). Therefore, f-PADDA's ability to precisely map by-passable DNA lesions of high mutagenic potential opens new opportunities for multiple studies, including the early detection of cancer precursor DNA lesions in high risk populations.

Of major importance, we documented that WT cells have significantly lower levels of endogenous DNA damage in the transcribed strand than in the non-transcribed strand of the actively transcribed CAN1 gene. These results strongly support the conclusion that WT cells repair endogenous damage preferentially on the transcribed strand, and strengthens a link between repair of endogenous damage and transcription. Given the functional overlap between BER and NER in the repair of oxidative damage, the preferential repair of endogenous damage on the transcribed strand could potentially occur through NER and/or BER. For example, transcription-dependent repair of 8-OxoG has been reported in E. coli (49) and mouse embryonic fibroblasts (50,51), and was shown to require CSA and CSB, proteins with a known role in TC-NER, as well as Ogg1, a BER DNA N-glycosylase (49-51). Here we show that the rate of endogenous damage accumulation is significantly higher in the transcribed than in the non-transcribed strand of BER⁻ cells. Additionally, and in contrast with WT cells, BER⁻ cells in stationary phase have significantly more DNA damage in the transcribed strand than in the non-transcribed strand. These data are consistent with recent biochemical and in vitro data (19) and strongly support a major role for BER in the preferential repair of endogenous DNA damage in the transcribed strand of actively transcribed genes.

We have documented here for the first time that persistent endogenous nucleotide damage as identified by f-PADDA in the CAN1 gene co-localizes with literature reported spontaneous gene mutations, corroborating the theory that persistent endogenous DNA damage leads to mutation fixation.

We have also documented here, that the use of PADDA, on a real-time PCR setting, to quantify in vivo endogenous base damage in wild-type (WT) and BER defective (BER⁻) cells demonstrated that the levels of DNA damage vary significantly between yeast strains, stages of cell growth, and DNA strands. Furthermore, it allowed us to demonstrate for the first time that BER repairs preferentially endogenous DNA damage localized in the transcribed strand.

To the best of our knowledge, this is the first study to document differences in levels of endogenous DNA damage between strands in WT cells. Importantly, and consistent with the fact that we are detecting a variety of lesions with high sensitivity, we established significant differences between WT and BER⁻ cells on a per strand basis even during exponential phase, when the levels of ROS and DNA damage are expected to be the lowest. Furthermore, our work for the first time provides direct evidence for the preferential repair of endogenous DNA damage in the transcribed strand of actively transcribed genes.

Utility

The novel PADDA assay of the presently disclosed and claimed inventive concepts can be used to detect DNA damage in a wide variety of organisms and applications, including, but not limited to:

(1) Individuals with decreased repair capacity (due to subtle defects in DNA repair genes) which may represent currently unrecognized syndromes of cancer predisposition and other conditions. Additionally, other individuals might carry high burdens of DNA damage due to, for example, unrecognized genotoxic exposure. Detecting and protecting either of these groups of individuals was previously impossible before the presently disclosed and claimed inventive concepts. PADDA is able to identify these individuals by detecting higher burdens of damage. The identification of these individuals will lead to novel preventive and follow-up strategies.

(2) Assessment of cancer risk and evaluation of approaches to reduce this risk.

(3) Antioxidant diets are believed to reduce the burdens of damage and therefore reduce cancer risk and delay aging. Hence, PADDA can be used to evaluate dietary or therapeutic approaches to reduce cancer risk or to delay aging, and in general to assess cancer risk and to evaluate approaches to reduce this risk.

(4) Tanning is in vogue but the implications of this to skin cancer are still in their infancy. Sunscreens are intended to protect DNA from the genotoxic effects of UV light but contain other ingredients that directly or upon activation by sunlight can act as genotoxics themselves. PADDA can be used to evaluate tanning safety, sunscreen products and approaches and to distinguish between justified and unjustified claims.

(5) Prediction of response to drugs that act by damaging DNA, such as the majority of anti-cancer drugs. Measuring and monitoring the effects of therapeutic agents that mainly act by the induction of DNA damage (which is the case of most chemotherapy agents and radiotherapy strategies used to treat cancer) is another application for PADDA.

(6) Prediction of specificity of tissue target by drugs that act by damaging DNA, such as the majority of anti-cancer drugs. Cancer chemotherapy causes many problems including unpleasant, sometimes life threatening side effects, tumor resistance to drugs, and mutagenic effects of the drugs themselves that can cause secondary cancers and can increase the mutation rates of existing tumors, leading to the emergence of more invasive and aggressive disease. DNA damage and repair is central to many of these problems and, therefore, evaluating this process at fine levels of resolution in both transformed and normal cells will be important. Also, with the aim of improving the specificity of cancer therapy, novel sequence-specific cytotoxic agents are being developed that may allow some degree of gene targeting. Consequently, for the development and rational design of such agents, PADDA can be used to study in cells the sequence selectivity of and to investigate if the intended target is being hit and to what extent individual lesions are repaired.

(7) PADDA can be used to assess the implications of the significant variability in the levels of specific DNA repair proteins (between different human cancers or different tissues in the same individual) for overall or tissue specific DNA damage.

(8) PADDA can be used to measure levels of DNA damage in virtually any cell, exposed (or not) to DNA damaging agents, which is a common need in basic, translational and clinical research studies. Numerous studies using cutting edge technologies in modern biomedical research, including molecular biology, are often interested in measuring levels of DNA base damage and/or detecting the bases damaged in a specific sequence of nucleic acids such as a gene region. This need comes from many scenarios, such as cells exposed (or not) to DNA damaging agents. Moreover, it is now universally recognized that the levels and types of DNA damage affect the cell fate in a dramatic way: life or death. The cell often goes through an active cellular death process when higher levels of DNA damage are detected. Hence, DNA damage lies in the center of critical life and death decisions. Not surprisingly, some scientists claim that most cellular energy is spent in DNA repair activities intended to prevent too much cell death that would make human life barely possible. Hence, PADDA can be used to investigate crucial fields such as apoptosis (cell death) and DNA repair mechanisms.

(9) Transcription-coupled DNA repair is a process whereby transcribed regions of DNA are repaired at a higher rate than other regions. Efficiency of transcription coupled DNA repair affects the fate of a cell and can determine whether a cell becomes apoptotic, necrotic, or cancerous, and thus defects in transcription coupled DNA repair lead to a number of serious diseases. PADDA can be applied to the study of the processing of transcription coupled DNA repair and its effects on life.

(10) Another field of application of PADDA is the detection of DNA damage in foods to allow a better screening of DNA damage in human food, in order to better prevent consumption of food with high levels of dangerous chemicals. This may include, for example, detection of damage in DNA from vegetables contaminated with pesticides or other foods treated with various preservation agents.

(11) PADDA can be used for applications in molecular biology to characterize polymerase behavior under specified conditions. Because PADDA employs a DNA polymerase, multiple conditions in the primer extension can be used to assay properties of novel or established polymerases on damaged or undamaged templates, in the presence of different ions and ion concentrations.

In conclusion, the presently disclosed and claimed inventive concepts will improve our knowledge and understanding of for example (but not limited to):

(1) the levels of DNA damage present in cells,

(2) the biological responses to DNA damage,

(3) predisposition to cancer and other conditions, such as aging and neurologic diseases,

(4) evaluation of disease prevention strategies,

(5) determining individual susceptibility to specific genotoxic exposures,

(6) cancer research,

(7) cancer therapy,

(8) aging research,

(9) neurologic diseases research,

(10) transcription coupled DNA repair,

(11) estimation of the DNA repair capacity in various cell systems,

(12) monitoring of diets and life-styles intended to reduce the burden of DNA damage and ultimately reduce cancer risk or delay aging, and

(13) food screening.

The presently disclosed and claimed inventive concepts are not to be limited in scope by the specific embodiments described herein, since such embodiments are intended only as individual illustrations of certain aspects of the presently disclosed and claimed inventive concepts, and any functionally equivalent embodiments are within the scope of the presently disclosed and claimed inventive concepts. Indeed, various modifications of the methods of the presently disclosed and claimed inventive concepts, in addition to those shown and described herein, will become apparent to those skilled in the art from the foregoing description.

Further, although the presently disclosed and claimed inventive concepts and the advantages thereof have been described in detail, it should be understood that various changes, substitutions and alterations can be made herein without departing from the spirit and scope of the presently disclosed and claimed inventive concepts as defined by the appended claims. Moreover, the scope of the present application is not intended to be limited to the particular embodiments of the process, machine, items of manufacture, compositions of matter, means, methods and steps described in the specification. As one of ordinary skill in the art will readily appreciate from the disclosure of the presently disclosed and claimed inventive concepts, processes, machines, items of manufacture, compositions of matter, means, methods, or steps, presently existing or later to be developed that perform substantially the same function or achieve substantially the same result as the corresponding embodiments described herein may be utilized according to the presently disclosed and claimed inventive concepts. Accordingly, the appended claims are intended to include within their scope such processes, machines, items of manufacture, compositions of matter, means, methods, or steps.

Each of the references, patents or publications cited herein is incorporated by reference in its entirety.

### CITED REFERENCES

1. Doll, Rand Peto, R. (1981) The causes of cancer: quantitative estimates of avoidable risks of cancer in the United States today. J Natl Cancer Inst, 66, 1191-1308.
2. Hasty, P., Campisi, J., Hoeijmakers, J., van Steeg, H. and Vijg, J. (2003) Aging and Genome Maintenance Lessons from the Mouse? Science, 299, 1355-1359.
3. Cooke, M. S., Evans, M. D., Dizdaroglu, M. and Lunec, J. (2003) Oxidative DNA damage: mechanisms, mutation, and disease. FASEB J, 17, 1195-1214.
4. Bernstein, C., Bernstein, H., Payne, C. M. and Garewal, H. (2002) DNA repair/pro-apoptotic dual-role proteins in five major DNA repair pathways: fail-safe protection against carcinogenesis. Mutat Res, 511, 145-178.
5. Lindahl, T. and Wood, R. D. (1999) Quality control by DNA repair. Science., 286, 1897-1905.
6. Swanson, R. L., Morey, N. J, Doetsch, P. W. and Jinks-Robertson, S. (1999) Overlapping specificities of base excision repair, nucleotide excision repair, recombination, and translesion synthesis pathways for DNA base damage in Saccharomyces cerevisiae. Mol Cell Biol, 19, 2929-2935.
7. Cadet, J., Douki, T., Gasparutto, D. and Ravanat, J. L., (2003) Oxidative damage to DNA: formation, measurement and biochemical features. Mutat Res, 531, 5-23.
8. Beckman, K. B. and Ames, B. N. (1997) Oxidative decay of DNA J Biol Chem, 272, 19633-19636.
9. Anson, R. M., Mason, P. A. and Bohr, V. A. (2006) Gene-specific and mitochondrial repair of oxidative DNA damage. Methods Mol Biol, 314, 155-181.
10. (ESCODD), T.E.S.C.o.O.D.D. (2003) Measurement of DNA oxidation in human cells by chromatographic and enzymic methods. Free Radic Biol Med, 34, 1089-1099.
11. Evert, B. A., Salmon, T. B., Song, B., Jingjing, L., Siede, W. and Doetsch, P. W. (2004) Spontaneous DNA damage in Saccharomyces cerevisiae elicits phenotypic properties similar to cancer cells. J Bioi Chem, 279, 22585-22594.
12. Johansson, C., Moller, P., Forchhammer, L., Loft, S., Godschalk, R. W. L., Langie, S. A. S., Lumeij, S., Jones, G. D. D., Kwok, R. W. L., Azqueta, A. et al. (2009) An ECVAG trial on assessment of oxidative damage to DNA measured by the comet assay. Mutagenesis, 1-8.
13. Pfeifer, G. P., Chen, H. H., Komura, J. and Riggs, A. D. (1999) Chromatin structure analysis by ligation-mediated and terminal transferase-mediated polymerase chain reaction. Methods Enzymol, 304, 548-571.
14. Grimaldi, K. A., McGurk, C. J., McHugh, P. J. and Hartley, J. A. (2002) PCR-based methods for detecting DNA damage and its repair at the sub-gene and single nucleotide levels in cells. Mol Biotechnol, 20, 181-196.
15. Ayala-Torres, S., Chen, Y., Svoboda, T., Rosenblatt, J. and Van Houten, B. (2000) Analysis of gene-specific DNA damage and repair using quantitative polymerase chain reaction. Methods, 22, 135-147.
16. Kovalenko, O. A and Santos, J. H. (2009) Analysis of oxidative damage by gene-specific quantitative PCR Curr Protoc Hum Genet, Chapter 19, Unit 19 11.
17. Regenberg, B., During-Olsen, L., Kielland-Brandt, M. C. and Holmberg, S. (1999) Substrate specificity and gene expression of the amino-acid permeases in Saccharomyces cerevisiae. Current Genetics, 36, 317-328.
18. Tornaletti, S. (2009) DNA Repair in Mammalian Cells. Cellular and Molecular Life Sciences, 66, 1010-1020.
19. Banerjee, D., Mandal, S. M., Das, A, Hegde, M. L., Das, S., Bhakat, K. K., Boldogh, I., Sarkar, P. S., Mitra, S, and Hazra, T. K. (2011) Preferential Repair of Oxidized Base Damage in the Transcribed Genes of Mammalian Cells. Journal of Biological Chemistry, 286, 6006-6016.
20. Frosina, G. (2007) The current evidence for defective repair of oxidatively damaged DNA in Cockayne syndrome. Free Radical Biology and Medicine, 43, 165-177.
21. Smith, C. A., Baeten, J. and Taylor, J. S. (1998) The ability of a variety of polymerases to synthesize past site-specific cis-syn, trans-syn-II, (6-4), and Dewar photoproducts of thymidylyl-(3′-->5′)-thymidine. J Biol Chem, 273, 21933-21940.
22. Vigneault, F. and Drouin, R. (2005) Optimal conditions and specific characteristics of Vent exo− DNA polymerase in ligation-mediated polymerase chain reaction protocols. Biochem Cell Biol, 83, 147-165.
23. Garrity, P. A. and Wold, B. J. (1992) Effects of different DNA polymerases in ligation-mediated PCR: enhanced genomic sequencing and in vivo footprinting. Proc Natl Acad Sci USA, 89, 1021-1025.
24. Angers, M., Cloutier, J. F., Castonguay, A. and Drouin, R. (2001) Optimal conditions to use Pfu exo(−) DNA polymerase for highly efficient ligation-mediated polymerase chain reaction protocols. Nucleic Acids Res, 29, E83.
25. Blondal, T., Hjorleifsdottir, S. H., Fridjonsson, O. F., Aevarsson, A, Skirnisdottir, S., Hermannsdottir, A. G., Hreggvidsson, G. O., Smith, A. Y. and Kristjansson, J. K. (2003) Discovery and characterization of a thermostable bacteriophage RNA ligase homologous to T4 RNA ligase 1. Nucleic Acids Res, 31, 7247-7254.
26. Livak, K. J. and Schmittgen, T. D. (2001) Analysis of relative gene expression data using real-time quantitative PCR and the 2(-Delta Delta C(T)) Method. Methods, 25, 402-408.
27. Mattila, P., Korpela, J., Tenkanen, T. and Pitkanen, K. (1991) Fidelity of DNA synthesis by the Thermococcus litoralis DNA polymerase—an extremely heat stable enzyme with proofreading activity. Nucleic Acids Res, 19, 4967-4973.
28. Lang, G. I. and Murray, A. W. (2008) Estimating the Per-Base-Pair Mutation Rate in the Yeast Saccharomyces cerevisiae. Genetics, 178, 67-82.
29. Ohnishi, G., Endo, K., Doi, A., Fujita, A. and Daigaku, Y. (2004) Spontaneous mutagenesis in haploid and diploid Saccharomyces cerevisiae. Biochem Biophys Res Commun, 325, 928-933.
30. Ahmad, M. and Bussey, H. (1986) Yeast arginine permease: nucleotide sequence of the CANI gene. Curr Genet, 10, 587-592.
31. Winnier, A. R., Meir, J. Y., Ross, J. M., Tavernarakis, N., Driscoll, M., Ishihara, T., Katsura, I. and Miller, D. M., 3rd. (1999) UNC-4IUNC-37-dependent repression of motor neuron-specific genes controls synaptic choice in Caenorhabditis elegans. Genes Dev, 13, 2774-2786.
32. Sikorsky, J. A., Primerano, D. A., Fenger, T. W. and Denvir, J. (2004) Effect of DNA damage on PCR amplification efficiency with the relative threshold cycle method. Biochem Biophys Res Commun, 323, 823-830.
33. Laun, P., Pichova, A., Madeo, F., Fuchs, J., Ellinger, A., Kohlwein, S., Dawes, I., Frohlich, K. U. and Breitenbach, M. (2001) Aged mother cells of Saccharomyces cerevisiae show markers of oxidative stress and apoptosis. Mol Microbiol, 39, 1166-1173.
34. Rowe, L. A, Degtyareva, N. and Doetsch, P. W. (2008) DNA damage-induced reactive oxygen species (ROS) stress response in Saccharomyces cerevisiae. Free Rad Biol Med 45, 1167-1177.
35. Salmon, T. B., Evert, B. A, Song, B. and Doetsch, P. W. (2004) Biological consequences of oxidative stress-induced DNA damage in Saccharomyces cerevisiae. Nucl. Acids Res., 32, 3712-3723.
36. Kitsera, N., Stathis, D., Luhnsdorf, B., Muller, H., Carell, T., Epe, B. and Khobta, A. (2011) 8-Oxo-7,8-dihydroguanine in DNA does not constitute a barrier to transcription, but is converted into transcription-blocking damage by OGG 1. Nucleic Acids Res.
37. Komura, J. and Riggs, A. D. (1998) Terminal transferase-dependent PCR: a versatile and sensitive method for in vivo footprinting and detection of DNA adducts. Nucleic Acids Res, 26, 1807-1811.
38. McGurk, C. J., McHugh, P. J, Tilby, M. J., Grimaldi, K. A., and Hartley, J. A. (2001) Measurement of covalent drug-DNA interactions at the nucleotide level in cells at pharmacologically relevant doses. Methods Enzymol, 340, 358-376.
39. Luu, H, Zagaja, G., Dubauskas, Z., Chen, S., Smith, R, Watabe, K, Ichikawa, Y, Ichikawa, T., Davis, E., Le Beau, M. et al. (1998) Identification of a novel metastasissuppressor region on human chromosome 12. Cancer Res, 58, 3561-3565.
40. Pawar, v., Jingjing, L., Zhang, H, Patel, N., Kaur, N., Doetsch, P., Shadel, G. and Siede, W. (2009) Checkpoint kinase phosphorylation in response to endogenous oxidative DNA damage in repair-deficient stationary-phase Saccharomyces cerevisiae. Mech Ageing Dev, 130, 501-508.
41. Godschalk, R, Nair, I, van Schooten, F. I, Risch, A, Drings, P., Kayser, K, Dienemann, H and Bartsch, H (2002) Comparison of multiple DNA adduct types in tumor adjacent human lung tissue: effect of cigarette smoking. Carcinogenesis, 23, 2081-2086.
42. Demple, B. and Harrison, L. (1994) Repair of oxidative damage to DNA: enzymology and biology. Annu Rev Biochem, 63, 915-948.
43. Senturker, S., Auffret van der Kemp, P., You, H, Doetsch, P., Dizdaroglu, M. and Boiteux, S. (1998) Substrate specificities of the ntg1 and ntg2 proteins of Saccharomyces cerevisiae for oxidized DNA bases are not identical. Nucl. Acids Res., 26, 5270-5276.
44. Boiteux, S., Gajewski, E., Laval, land Dizdaroglu, M. (2002) Substrate specificity of the Escherichia coli Fpg protein formamidopyrimidine-DNA glycosylase: excision of purine lesions in DNA produced by ionizing radiation or photosensitization. Biochemistry, 31, 106-110.
45. Wiederholt, C. I, Patro, I N., Jiang, Y L., Haraguchi, K. and Greenberg, M. M. (2005) Excision offormamidopyrimidine lesions by endonucleases III and VIII is not a major DNA repair pathway in Escherichia coli. Nucl. Acids Res., 33, 3331-3338.
46. Errol C. Friedberg, G. C. W., Wolfram Siede, Richard D. Wood, Roger A Schultz, and Tom Ellenberger. (2005) DNA Repair and Mutagenesis. 2nd ed. American Society Microbiology, Washington, D.C.
47. Feig, D. I. and Loeb, L. A (1994) Oxygen radical induced mutagenesis is DNA polymerase specific. J Mol Biol, 235, 33-41.
48. Wang, D., Kreutzer, D. A and Essigmann, I M. (1998) Mutagenicity and repair of oxidative DNA damage: insights from studies using defined lesions. Mutat Res, 400, 99-115.
49. Bregeon, D., Doddridge, Z. A., You, R. J., Weiss, B. and Doetsch, P. W. (2003) Transcriptional mutagenesis induced by uracil and 8-oxoguanine in Escherichia coli. Mol Cell, 12, 959-970.
50. Spivak, G. and Hanawalt, P. e. (2006) Host cell reactivation of plasmids containing oxidative DNA lesions is defective in Cockayne syndrome but normal in UV-sensitive syndrome fibroblasts. DNA Repair (Amst), 5, 13-22.
51. Pastoriza-Gallego, M., Armier, J. and Sarasin, A. (2007) Transcription through 8-oxoguanine in DNA repair-proficient and Csb/Oggl DNA repair-deficient mouse embryonic fibroblasts is dependent upon promoter strength and sequence context. Mutagenesis, 22, 343-351.
52. Kim, N. and Jinks-Robertson, S. (2010) Abasic sites in the transcribed strand of yeast DNA are removed by transcription-coupled nucleotide excision repair. Mol Cell Biol.
53. Fuchs J, Podda M and Packer L. (2003). Redox-Genome Interactions in Health and Disease. Marcel Dekker Press, Volume 10, p. 145-192.
54. Santos J H. Mandavilli B S. Van Houten B (2002). Measuring oxidative mtDNA damage and repair using quantitative PCR. Methods in Molecular Biology (Copeland W. C., ed.), Humana Press, NJ, pp. 197: 159-76.
55. Van Houten B. Cheng S. Chen Y. (2000) Measuring gene-specific nucleotide excision repair in human cells using quantitative amplification of long targets from nanogram quantities of DNA. Mutation Research. 460(2):81-94.
56. Yakes, F. M., Chen, Y., and Van Houten, B. (1996). PCR-based assays for the detection and quantitation of DNA damage and repair, in Technologies for Detection of DNA Damage and Mutations (Pfeifer, G. P., ed.), Plenum, New York, pp. 171-184.
57. Kalinowski D., Illenye, S., Van Houten, B. (1992). Analysis of DNA damage and repair in murine leukemia L1210 cells using a quantitative polymerase chain reaction assay. Nucleic Acids Res. 20, pp. 3485-3494.
58. Loeb, L. A. & Monnat, R. J. DNA polymerases and human disease. Nat Rev Genet. 9, 594-604 (2008).
59. Keohavong, P., Ling, L., Dias, C. & Thilly, W. G. Predominant mutations induced by the Thermococcus litoralis, vent DNA polymerase during DNA amplification in vitro. PCR Methods Appl 2, 288-292 (1993).
60. Fischhaber, P. L. et al. Human DNA polymerase kappa bypasses and extends beyond thymine glycols during translesion synthesis in vitro, preferentially incorporating correct nucleotides. J Biol Chem 277, 37604-37611 (2002).
61. Hoeijmakers, J. H. Genome maintenance mechanisms for preventing cancer. Nature 411, 366-374 (2001).
62. Prakash, S. & Prakash, L. Nucleotide excision repair in yeast. Mutation Research 451, 13-24 (2000).
63. Reis, A. M. et al. Genotype-specific Trp53 mutational analysis in ultraviolet B radiation-induced skin cancers in Xpc and Xpc Trp53 mutant mice. Cancer Res 60, 1571-1579 (2000).
64. Nahari, D. et al. Mutations in the Trp53 gene of UV-irradiated Xpc mutant mice suggest a novel Xpc-dependent DNA repair process. DNA Repair (Amst) 3, 379-386, 2004.
65. Errol C. Friedberg et al. DNA Repair and Mutagenesis. 2nd edn, (American Society Microbiology, 2005).
66. Kantor, G. J. & Elking, C. F. Biological significance of domain-oriented DNA repair in xeroderma pigmentosum cells. Cancer Res 48, 844-849 (1988).
67. Kantor, G. J., Barsalou, L. S. & Hanawalt, P. C. Selective repair of specific chromatin domains in UV-irradiated cells from xeroderma pigmentosum complementation group C. Mutat Res 235, 171-180 (1990).
68. Venema, J. et al. Xeroderma pigmentosum complementation group C cells remove pyrimidine dimers selectively from the transcribed strand of active genes. Mol Cell Biol 11, 4128-4134 (1991).
69. Reis, A. M. et al. Genotype-specific Trp53 mutational analysis in ultraviolet B radiation-induced skin cancers in Xpc and Xpc Trp53 mutant mice. Cancer Res 60, 1571-1579 (2000).
70. Denissenko, M. F., Pao, A., Tang, M. & Pfeifer, G. P. Preferential formation of benzo[a]pyrene adducts at lung cancer mutational hotspots in P53. Science 274, 430-432 (1996).
71. Crowe, D. L., Hacia, J. G., Hsieh, C. L., Sinha, U. K. & Rice, H. Molecular pathology of head and neck cancer. Histol Histopathol 17, 909-914. (2002).
72. Jemal, A. et al. Cancer statistics, 2004. CA Cancer J Clin 54, 8-29 (2004).
73. Nadin, S. B., Vargas-Roig, L. M., Drago, G., Ibarra, J. & Ciocca, D. R. DNA damage and repair in peripheral blood lymphocytes from healthy individuals and cancer patients: a pilot study on the implications in the clinical response to chemotherapy. Cancer Lett 239, 84-97 (2006).
74. Livak, K. J. & Schmittgen, T. D. Analysis of relative gene expression data using real-time quantitative PCR and the 2(-Delta Delta C(T)) Method. Methods 25, 402-408 (2001).
75. Rodriguez, H. & Akman, S. A. Mapping oxidative DNA damage at nucleotide level. Free radical research 29, 499-510 (1998).
76. Akman, S. A., O'Connor, T. R. & Rodriguez, H. Mapping Oxidative DNA Damage and Mechanisms of Repair. Annals of the New York Academy of Sciences 899, 88-102 (2000).
77. Heaton, P. R. et al. Application of single-cell gel electrophoresis (comet) assay for assessing levels of DNA damage in canine and feline leukocytes. J Nutr 132, 1598S-1603S (2002).
78. Rothfuss, O., Gasser, T. & Patenge, N. Analysis of differential DNA damage in the mitochondrial genome employing a semi-long run real-time PCR approach. Nucleic Acids Research 38, e24, doi:10.1093/nar/gkp1082 (2010).
79. Senturker, S. et al. Substrate specificities of the ntg1 and ntg2 proteins of Saccharomyces cerevisiae for oxidized DNA bases are not identical. Nucl. Acids Res. 26, 5270-5276, doi:10.1093/nar/26.23.5270 (1998).
80. Boiteux, S., Gajewski, E., Laval, J. & Dizdaroglu, M. Substrate specificity of the Escherichia coli Fpg protein formamidopyrimidine-DNA glycosylase: excision of purine lesions in DNA produced by ionizing radiation or photosensitization. Biochemistry 31, 106-110, doi:10.1021/bi00116a016 (2002).
81. Wiederholt, C. J., Patro, J. N., Jiang, Y. L., Haraguchi, K. & Greenberg, M. M. Excision of formamidopyrimidine lesions by endonucleases III and VIII is not a major DNA repair pathway in Escherichia coli. Nucl. Acids Res. 33, 3331-3338, doi:10.1093/nar/gki655 (2005).
82. Stein, V. & Hollfelder, F. An efficient method to assemble linear DNA templates for in vitro screening and selection systems. Nucleic Acids Research 37, -, doi:ARTN e122, DOI 10.1093/nar/gkp589 (2009).
83. Teng, Y. et al. A novel method for the genome-wide high resolution analysis of DNA damage. Nucleic Acids Research 39, e10, doi:10.1093/nar/gkq1036 (2011).
84. Rodriguez, H., Holmquist, G. P., D'Agostino, R., Jr., Keller, J. & Akman, S. A. Metal ion-dependent hydrogen peroxide-induced DNA damage is more sequence specific than metal specific. Cancer Research 57, 2394-2403 (1997).
85. Lundin, C. et al. Methyl methanesulfonate (MMS) produces heat-labile DNA damage but no detectable in vivo DNA double-strand breaks. Nucleic Acids Research 33, 3799-3811, doi:10.1093/nar/gki681 (2005).
86. Cooke, M. S., Evans, M. D., Dizdaroglu, M. & Lunec, J. Oxidative DNA damage: mechanisms, mutation, and disease. FASEB J. 17, 1195-1214, doi:10.1096/fj.02-0752rev (2003).
87. Beranek, D. T. Distribution of methyl and ethyl adducts following alkylation with monofunctional alkylating agents. Mutation Research 231, 11-30 (1990).
88. Encell, L., Shuker, D. E., Foiles, P. G. & Gold, B. The in vitro methylation of DNA by a minor groove binding methyl sulfonate ester. Chemical research in toxicology 9, 563-567, doi:10.1021/tx9501849 (1996).
89. Guillet, M. & Boiteux, S. Endogenous DNA abasic sites cause cell death in the absence of Apn1, Apn2 and Rad1/Rad10 in Saccharomyces cerevisiae. European Molecular Biology Organization 21, 2833-2841 (2002).
90. Greagg, M. A. et al. A read-ahead function in archaeal DNA polymerases detects promutagenic template-strand uracil. Proceedings of the National Academy of Sciences of the United States of America 96, 9045-9050 (1999).
91. Nahari, D. et al. Mutations in the Trp53 gene of UV-irradiated Xpc mutant mice suggest a novel Xpc-dependent DNA repair process. DNA Repair (Amst). 3, 379-386. (2004).
92. Hemminki, K. et al. Demonstration of UV-dimers in human skin DNA in situ 3 weeks after exposure. Carcinogenesis 23, 605-609 (2002).
93. Bohr, V. A., Smith, C. A., Okumoto, D. S. & Hanawalt, P. C. DNA repair in an active gene: removal of pyrimidine dimers from the DHFR gene of CHO cells is much more efficient than in the genome overall. Cell 40, 359-369 (1985).
94. Mellon, I., Spivak, G. & Hanawalt, P. C. Selective removal of transcription-blocking DNA damage from the transcribed strand of the mammalian DHFR gene. Cell 51, 241-249 (1987).
95. van Hoffen, A., Venema, J., Meschini, R., van Zeeland, A. A. & Mullenders, L. H. Transcription-coupled repair removes both cyclobutane pyrimidine dimers and 6-4 photoproducts with equal efficiency and in a sequential way from transcribed DNA in xeroderma pigmentosum group C fibroblasts. Embo J 14, 360-367 (1995).
96. Cheo, D. L. et al. Characterization of defective nucleotide excision repair in XPC mutant mice. Mutation Res 374, 1-9 (1997).
97. Smith, C. A., Baeten, J. & Taylor, J. S. The ability of a variety of polymerases to synthesize past site-specific cis-syn, trans-syn-II, (6-4), and Dewar photoproducts of thymidylyl-(3′-->5)-thymidine. J Biol Chem 273, 21933-21940 (1998).
98. Hsieh, L. L. et al. Characteristics of mutations in the p53 gene in oral squamous cell carcinoma associated with betel quid chewing and cigarette smoking in Taiwanese. Carcinogenesis 22, 1497-1503 (2001).

What is claimed is:

1. A method of identifying damage in DNA, comprising:
exposing a sample of single-stranded template DNA to a DNA polymerase and to tagged oligonucleotide primers specific to the template DNA under a condition suitable for primer extension;
conducting a single, non-cycled primer extension reaction of the template DNA, DNA polymerase, and tagged oligonucleotide primers producing a pool of tagged DNA extension products, at least some of which are specific to the template DNA;
purifying the pool of tagged DNA extension products to remove unused tagged oligonucleotide primers; and
conducting an analysis of the purified pool of tagged DNA extension products to characterize the damage in the template DNA.

2. The method of claim 1 wherein the analysis of the purified pool of tagged DNA extension products comprises real-time PCR analysis for quantifying DNA damage.

3. The method of claim 2 wherein the quantification of DNA damage can be obtained within at least one of 1, 2, 3, 4, 5, 6 or 7 hours.

4. The method of claim 2 wherein the analysis comprises using an internal normalization control oligonucleotide primer set to account for the presence of undamaged template DNA.

5. The method of claim 1 wherein the condition suitable for primer extension includes a specific ion and/or a specific concentration of said ion.

6. The method of claim 1 wherein the characterization of the damage comprises mapping and quantification of the damage in the template of DNA.

7. The method of claim 1 wherein the single, non-cycled primer extension reaction occurs in the absence of the use of a DNA repair enzyme to remove lesions.

8. The method of claim 1 wherein in the single, non-cycled primer extension reaction, a DNA repair enzyme is used to remove lesions.

9. The method of claim 1 wherein the tagged oligonucleotide primers comprise a tag that can be used for separation from genomic DNA or for unique identification in subsequent steps.

10. The method of claim 9 wherein the tag is biotin.

11. The method of claim 1 wherein the DNA polymerase is a polymerase able to identify damaged bases and/or nucleotides.

12. The method of claim 11 wherein the DNA polymerase is at least one of Vent exo⁻, Vent, Dpo4, and Taq.

13. The method of claim 1 wherein in the purifying step, the unused primers are removed by exonuclease digestion before the primer extension products are released from the template DNA.

14. The method of claim 1 wherein the damage in the template DNA is in at least one position or former position of a nucleotide or a base.

15. The method of claim 1 wherein the damage in the template DNA is at least one of endogenous damage and induced damage.

16. The method of claim 1 wherein the analysis of the purified pool of tagged DNA extension products comprises using a single-strand DNA ligase to ligate the tagged DNA extension products to an oligonucleotide adapter-primer to form adapter-ligated extension products.

17. The method of claim 16 wherein the oligonucleotide adapter-primer comprises a sequence that is distinct from the target genome being tested.

18. The method of claim 16 wherein the oligonucleotide adapter-primer contains in the 5′ end a phosphoryl group and in the 3′ end a dideoxy cytosine.

19. The method of claim 16 wherein the oligonucleotide adapter-primer contains in the 3′ end one or more phosphorothioate linkages.

20. The method of claim 16 wherein an oligonucleotide complementary to the 3′ end of the oligonucleotide primer used in the primer extension may be used in the single-strand ligation reaction to prevent non-specific ligation of any residual tagged oligonucleotide primer to the adapter primer.

21. The method of claim 16 wherein the pool of tagged DNA extension products comprises a DNA extension product comprising a stop, which represents replicative arrest by a damaged nucleotide, a nick, or a random stalling of the DNA polymerase in the DNA template.

22. The method of claim 16 wherein the pool of tagged DNA extension products comprises a DNA extension product comprising a stop with misincorporation (SM), which represents replicative arrest with misincorporation at the site of a damage nucleotide, a nick, or a random stalling of the DNA polymerase in the DNA template.

23. The method of claim 16 wherein the pool of tagged DNA extension products comprises a DNA extension product comprising a lesion bypass with misincorporation (LBM), which represents bypass with misincorporation at the site of a damaged nucleotide.

24. The method of claim 16 wherein the pool of tagged DNA extension products comprises a DNA extension product comprising a complex stop with misincorporation (CSM), which represents replicative arrest with a tandem misincorporation at the site of a damaged or tandemly damaged nucleotide or nucleotides, a nick, or a random stalling of the DNA polymerase in the DNA template.

25. The method of claim 16 wherein the pool of tagged DNA extension products comprises a DNA extension product comprising a complex lesion bypass with misincorporation (CLBM), which represents replicative bypass with a tandem or multiple misincorporation at the site of a damaged or tandemly or multiply damaged nucleotide or nucleotides.

26. The method of claim 16 comprising: (1) PCR amplification of the adapter-ligated extension products to form an amplified pool of the adaptor-ligated extension, (2) product cloning and transformation with the amplified pool of adaptor-ligated extension products, and (3) colony PCR and sequencing of the adaptor-ligated extension products, or (4) any method to determine the nucleotide sequence of extended products.

27. The method of claim 16 comprising: (1) dilution of the adaptor-ligated extension products to one of said adaptor-ligated extension products per well, (2) amplification of each adaptor-ligated extension product by real-time high fidelity PCR, and (3) sequencing of the amplified adaptor-ligated extension products in each well.

28. The method of claim 1, comprising: treating the template DNA with a DNA repair kit so as to produce minimal and approximately equal levels of DNA damage in each strand so that overall levels of DNA damage can be detected in each strand of a specific genotype.

29. The method of claim 1 comprising an assay for identifying individual susceptibility to specific genotoxics.

30. The method of claim 1 comprising an assay for identifying individual levels of overall and site specific DNA damage and determining cancer risk.

31. The method of claim 1 comprising an assay for determining and/or predicting response to a variety of chemo and radio-therapeutic agents.

32. The method of claim 1 comprising an assay for studying polymerases and polymerase behavior at certain lesions.

33. The method of claim 1 comprising an assay for studying polymerase behavior dependent on ion and ion concentration at damaged or non-damaged nucleotides.

34. The method of claim 1 comprising an assay for studying nucleotide specific roles of DNA repair pathways.

35. The method of claim 1 comprising an assay for studying any process as it relates to DNA damage and repair.

36. A kit for identifying damage in DNA, comprising:
at least one DNA polymerase;
tagged oligonucleotide primers specific to at least one template DNA to be tested;
at least one oligonucleotide adapter-primer; and
at least one exonuclease for digesting unused primers.

37. The kit of claim 36, wherein the kit is absent a DNA repair enzyme.


SEQUENCE LISTING (52 sequences)

SEQ ID NO: 1 - DNA, 64 bp, Artificial Sequence
  Artificially synthesized
ccactcaccgtgcacataacagacttggctgtcccagactgcaggaagcccaggtggaagccat

SEQ ID NO: 2 - DNA, 64 bp, Artificial Sequence
  Artificially synthesized
ccactcaccntgcacataacagacttggctgtcccagactgcaggaagcccaggtggaagccat

SEQ ID NO: 3 - DNA, 63 bp, Artificial Sequence
  Artificially synthesized
ccactctccatgcacataacagacttggctcacctgcactcaggaagcccaggtggaagccat

SEQ ID NO: 4 - DNA, 63 bp, Artificial Sequence
  Artificially synthesized
ccactcaccggcacataacagacttggctgtcccagactgcaggaagcccaggtggaagccat

SEQ ID NO: 5 - DNA, 65 bp, Artificial Sequence
  Artificially synthesized
ccactctccatgcacataacagacttggctgtgcncggtgctcaggaagcccaggtggaagccat

SEQ ID NO: 6 - DNA, 35 bp, Artificial Sequence
  Artificially synthesized
cttaccagggcaactatggcttccacctgggcttc

SEQ ID NO: 7 - DNA, 18 bp, Artificial Sequence
  Artificially synthesized
cttccacctgggcttcct

SEQ ID NO: 8 - DNA, 35 bp, Artificial Sequence; identical to SEQ ID NO: 6
  Artificially synthesized

SEQ ID NO: 9 - DNA, 30 bp, Artificial Sequence
  Artificially synthesized
caggctgaagaggaacccccaaatctagac

SEQ ID NO: 10 - DNA, 29 bp, Artificial Sequence
  Artificially synthesized
cattgaaaggtcacacgaaagacaactcc

SEQ ID NO: 11 - DNA, 31 bp, Artificial Sequence
  Artificially synthesized
cctgcagtctgggacagccaagtctgttatg

SEQ ID NO: 12 - DNA, 20 bp, Artificial Sequence
  Artificially synthesized
caactccccggggcccactc

SEQ ID NO: 13 - DNA, 25 bp, Artificial Sequence
  Artificially synthesized
cattgaaaggtcacacgaaagacaa

SEQ ID NO: 14 - DNA, 27 bp, Artificial Sequence
  Artificially synthesized
ctagacagagaaaaagaggcattgaaa

SEQ ID NO: 15 - DNA, 32 bp, Artificial Sequence
  Artificially synthesized
cctgcagtctgggacagccaagtctgttatgt

SEQ ID NO: 16 - DNA, 18 bp, Artificial Sequence
  Artificially synthesized
tccatgctcaggctggcc

SEQ ID NO: 17 - DNA, 26 bp, Artificial Sequence
  Artificially synthesized
aaggaaaggtgataaaagtgaatctg

SEQ ID NO: 18 - DNA, 20 bp, Artificial Sequence
  Artificially synthesized
gcgacagagcgagattccat

SEQ ID NO: 19 - DNA, 25 bp, Artificial Sequence
  Artificially synthesized
ctgaggcataactgcacccttggtc

SEQ ID NO: 20 - DNA, 21 bp, Artificial Sequence
  Artificially synthesized
cctgcttgccacaggtctccc

SEQ ID NO: 21 - DNA, 26 bp, Artificial Sequence
  Artificially synthesized
aggacctgatttccttactgcctctt

SEQ ID NO: 22 - DNA, 22 bp, Artificial Sequence
  Artificially synthesized
tgcttgccacaggtctccccaa

SEQ ID NO: 23 - DNA, 25 bp, Artificial Sequence
  Artificially synthesized
tagttgtagtggatggtggtacagt

SEQ ID NO: 24 - DNA, 30 bp, Artificial sequence
  Artificially synthesized
cgttggttcccgtattttatttggtctatc

SEQ ID NO: 25 - DNA, 41 bp, Artificial sequence
  Artificially synthesized
gtatggtttgtggtgctggggttaccggcccagttggattc

SEQ ID NO: 26 - DNA, 38 bp, Artificial Sequence
  Artificially synthesized
ctctggtacaaaggttttgccacatatcttcaacgctg

SEQ ID NO: 27 - DNA, 35 bp, Artificial Sequence
  Artificially synthesized
gttttgccacatatcttcaacgctgttatcttaac

SEQ ID NO: 28 - DNA, 37 bp, Artificial Sequence
  Artificially synthesized
accaaataaaatacgggaaccaacgtaaatatttgaa

SEQ ID NO: 29 - DNA, 33 bp, Artificial Sequence
  Artificially synthesized
gctacaacattccaaaatttgtcccaaaaagtc

SEQ ID NO: 30 - DNA, 29 bp, Artificial Sequence
  Artificially synthesized
ttggttcccgtattttatttggtctatca

SEQ ID NO: 31 - DNA, 16 bp, Artificial Sequence
  Artificially synthesized
ttggctcctaaattcc

SEQ ID NO: 32 - DNA, 15 bp, Artificial Sequence
  Artificially synthesized
ggtcgcttccatcaa

SEQ ID NO: 33 - DNA, 17 bp, Artificial Sequence
  Artificially synthesized
tgccacatatcttcaac

SEQ ID NO: 34 - DNA, 16 bp, Artificial Sequence
  Artificially synthesized
ctttggtggtccttga

SEQ ID NO: 35 - DNA, 17 bp, Artificial Sequence
  Artificially synthesized
cgacatctccaatcttc

SEQ ID NO: 36 - DNA, 20 bp, Artificial Sequence
  Artificially synthesized
ccacctttggtggtccttga

SEQ ID NO: 37 - DNA, 22 bp, Artificial Sequence
  Artificially synthesized
ttctgccgcaaattcaaatatt

SEQ ID NO: 38 - DNA, 23 bp, Artificial Sequence
  Artificially synthesized
aaatattacggtgaattcgagtt

SEQ ID NO: 39 - DNA, 25 bp, Artificial Sequence
  Artificially synthesized
catatcttcaacgctgttatcttaa

SEQ ID NO: 40 - DNA, 21 bp, Artificial Sequence
  Artificially synthesized
gaatttaggagccaacttgtt

SEQ ID NO: 41 - DNA, 33 bp, Artificial Sequence; identical to SEQ ID NO: 29
  Artificially synthesized

SEQ ID NO: 42 - DNA, 38 bp, Artificial Sequence
  Artificially synthesized
aggcatgagaaccatctgcagtacgtcctggtcagcag

SEQ ID NO: 43 - DNA, 33 bp, Artificial Sequence
  Artificially synthesized
aaaaaggacaaaccgacggcagaaaacccagga

SEQ ID NO: 44 - DNA, 38 bp, Artificial Sequence
  Artificially synthesized
aggatatggcctacgatcagcagtacgtcgtgctcagc

SEQ ID NO: 45 - DNA, 29 bp, Artificial Sequence
  Artificially synthesized
ccaggacgtactgcagatggttctcatgc

SEQ ID NO: 46 - DNA, 25 bp, Artificial Sequence
  Artificially synthesized
gtcctgggttttctgccgtcggttt

SEQ ID NO: 47 - DNA, 31 bp, Artificial Sequence
  Artificially synthesized
cacgacgtactgctgatcgtaggccatatcc

SEQ ID NO: 48 - DNA, 31 bp, Artificial Sequence
  Artificially synthesized
gtagcatcacgctgtgagtaagttctaaacc

SEQ ID NO: 49 - DNA, 29 bp, Artificial Sequence
  Artificially synthesized
ggttcctgatgaggtggttagcatagttc

SEQ ID NO: 50 - DNA, 27 bp, Artificial Sequence
  Artificially synthesized
ctgcaatgtatggaacaccacctttgg

SEQ ID NO: 51 - DNA, 34 bp, Artificial Sequence
  Artificially synthesized
gcaatgtatggaacaccacctttggtggtccttg

SEQ ID NO: 52 - DNA, 28 bp, Artificial Sequence
  Artificially synthesized
ggtccttgacaggaatttaggagccaac